(19) United States
(12) Patent Application Publication
(10) Pub. No.: US 2025/0274326 A1
(43) Pub. Date: Aug. 28, 2025

(54) INSERTION OF DISTRIBUTED REFERENCE SIGNALS IN DFT-S-OFDM

(71) Applicant: INTERDIGITAL PATENT HOLDINGS, INC., Wilmington, DE (US)

(72) Inventors: Javier Lorca Hernando, London (GB); Hussain ELKOTBY, Conshohocken, PA (US); Ahmed Serdar TAN, London (GB); Onur GOYAL, Deer Park, NY (US); Pascal ADJAKPLE, New York, NY (US); Umer SALIM, Vallauris (FR); Ravikumar PRAGADA, conshohocken, PA (US)

(21) Appl. No.: 18/856,815

(22) PCT Filed: Apr. 14, 2023
(86) PCT No.: PCT/US2023/018634

§ 371 Date: Oct. 14, 2024

(51) Int. Cl. H04L 27/26; H04L 1/20; H04L 5/00

(52) U.S. Cl. CPC H04L 27/2636; H04L 1/203; H04L 5/0098

(57) ABSTRACT

Some implementations provide devices, methods and systems for receiving data over a Discrete Fourier Transform-spread Orthogonal Frequency Division Multiplexing (DFT-s-OFDM) waveform. A Reference Signal (RS) configuration message is received. A padding sequence structure is determined based on a received indication. A DFT-s-OFDM symbol is received. Interference is cancelled based on the padding sequence structure. In some implementations, the padding sequence structure includes a constant-envelope sequence, sign-reversed data symbols, phase-shifted data symbols, and/or blank symbols. In some implementations, the RS configuration message includes an RS sequence, a RS length, and/or a subcarrier offset.

### CROSS-REFERENCE TO RELATED APPLICATIONS

This application claims the benefit of U.S. Provisional Application No. 63/331,031, filed Apr. 14, 2022, the contents of each are incorporated herein by reference.

### BACKGROUND

Discrete Fourier Transform-spread Orthogonal Frequency Division Multiplexing (DFT-s-OFDM) is a single-carrier waveform, e.g., as adopted by Third Generation Partnership Project (3GPP) for the uplink of 4G Long-Term Evolution (LTE) and 5G New Radio (NR) wireless cellular standards.

Unlike other multicarrier waveforms like Cyclic Prefix-Orthogonal Frequency Division Multiplexing (CP-OFDM), the single-carrier nature of DFT-s-OFDM may allow a reduced peak-to-average power ratio (PAPR) while retaining other benefits of CP-OFDM, such as DFT-based frequency-domain equalization and simple inter-symbol interference (ISI) mitigation. The efficiency of the power amplifiers (PA) may improve with a reduced PAPR because the range of output powers where the device keeps a linear response may be larger, delivering higher output power for the same PA technology. This property may be especially relevant when carrier frequencies are increased beyond Frequency Range 2 (FR2), i.e., above 52.6 GHZ, as PA efficiency starts to shrink dramatically at these higher frequencies.

DFT-s-OFDM may be basically characterized by a Transform Precoding stage added to the normal processing steps in CP-OFDM. In some implementations, transform precoding may achieve a single-carrier waveform in the time domain only if subcarriers are mapped to contiguous frequency positions, which may limit the flexibility of DFT-s-OFDM to allocate control and data information in the frequency domain. In some implementations, for this reason, control and data channels in 5G NR, in some implementations, are not multiplexed in frequency but are allocated different DFT-s-OFDM symbols so that the single-carrier nature is preserved. This may also be applicable to some 5G NR Reference Signals (RS), such as DM-RS, which does not allow multiplexing of data information in the same symbol.

### SUMMARY

Some implementations provide a method for receiving data over a DFT-s-OFDM waveform. A RS configuration message is received. A padding sequence structure is determined based on a received indication. A DFT-s-OFDM symbol is received. Interference is cancelled based on the padding sequence structure. In some implementations, the padding sequence structure includes a constant-envelope sequence, sign-reversed data symbols, phase-shifted data symbols, and/or blank symbols. In some implementations, the RS configuration message includes an RS sequence, a RS length, and/or a subcarrier offset. In some implementations, the RS configuration message is received in a DCI, a MAC CE, and/or a RRC message. In some implementations, the received indication includes a padding sequence structure identifier and/or a codebook index. In some implementations, the received indication is received in a DCI, a MAC CE, and/or a RRC message. In some implementations, the padding sequence structure is estimated by blind detection based on the received indication. In some implementations, cancelling the interference includes cancelling the interference from the DFT-s-OFDM symbol based on the padding sequence structure. In some implementations, cancelling the interference based on the padding sequence structure includes cancelling interference due to insertion of the RS into the DFT-s-OFDM symbol. In some implementations, cancelling the interference based on the padding sequence structure includes cancelling the interference from the DFT-s-OFDM symbol prior to demodulation. Some implementations also include transmitting feedback based on the cancelling of the interference. The feedback includes an indication of a performance of the canceling of the interference, an indication of a preferred padding sequence structure, an indication of a BER, and/or an indication of a BLER.

Some implementations provide a WTRU configured for receiving data over a DFT-s-OFDM waveform. The WTRU includes circuitry configured to receive a RS configuration message. The WTRU also includes circuitry configured to determine a padding sequence structure based on a received indication. The WTRU also includes circuitry configured to receive a DFT-s-OFDM symbol. The WTRU also includes circuitry configured to cancel interference based on the padding sequence structure. In some implementations, the padding sequence structure includes at least one of: a constant-envelope sequence, sign-reversed data symbols, phase-shifted data symbols, or blank symbols. In some implementations, the RS configuration message includes at least one of: an RS sequence, a RS length, or a subcarrier offset. Some implementations also include circuitry configured to receive the RS configuration message in a DCI, a MAC CE, and/or a RRC message. In some implementations, the received indication includes a padding sequence structure identifier or a codebook index. Some implementations also include circuitry configured to receive the indication in a DCI, a MAC CE, and/or a RRC message. Some implementations also include circuitry configured to estimate the padding sequence structure by blind detection based on the received indication. Some implementations also include circuitry configured to cancel the interference from the DFT-s-OFDM symbol based on the padding sequence structure. Some implementations also include circuitry configured to cancel interference due to insertion of the RS into the DFT-s-OFDM symbol. Some implementations also include circuitry configured to cancel the interference from the DFT-s-OFDM symbol prior to demodulation. Some implementations also include circuitry configured to transmit feedback based on the cancelling of the interference. The feedback includes an indication of a performance of the canceling of the interference, an indication of a preferred padding sequence structure, an indication of a BER, and/or an indication of a BLER.

Some implementations provide devices, methods and systems for post-DFT RS insertion based on padding sequence adaptation. Information is received, in a RS configuration message, about the characteristics of the inserted RS, e.g. the RS sequence to use, its length, or a first subcarrier offset. Measurements are performed, e.g., PAPR, on one or more generated signals, wherein the generated signal is a time domain signal encompassing signals addressed to a second WTRU or a set of second WTRUs. Measurements, e.g. PAPR, are compared against a first threshold. The one or multiple padding sequence structures are updated from a padding sequence structure codebook based on PAPR measurements. Signaling information is sent to the second WTRU or set of second WTRUs, e.g. on the padding sequence structures used. A first set of symbols is constructed by appending the one or multiple padding sequences to a second set of complex modulated data symbols in a DFT-s-OFDM symbol. A DFT operation is performed on the first set of symbols to determine discrete frequency response on a first set of subcarriers. A subset of the subcarriers is punctured and the complex RS symbols are inserted at the locations of the punctured subcarriers in the frequency domain to obtain a second set of subcarriers. IFFT is performed on the second set of subcarriers and transmitting a DFT-s-OFDM symbol including data and RS.

Some implementations provide devices, methods and systems for post-DFT RS insertion based on padding sequence adaptation. Information is received, in a RS configuration message, about the characteristics of the inserted RS, e.g., the RS sequence to use, its length, or a first subcarrier offset. Feedback information is received from the second WTRU, e.g., time-domain reporting messages and decoding performance, e.g., BLER. measurements are performed, e.g., PAPR, on one or more generated signal(s) and comparing against a first threshold, wherein the generated signal is a time domain signal encompassing signals addressed to a second WTRU or a set of second WTRUs. Time-domain reporting messages, e.g., the maximum autocorrelation, are compared against a second threshold. A decoding performance, e.g., BLER, is compared against a third threshold. One or more padding sequence structures are selected from a subset of the padding sequence structure codebook characterized by a lower PAPR based on PAPR measurements or feedback information being above a first or second threshold. One or more padding sequence structures are selected from a subset of the padding sequence structure codebook characterized by a lower BLER based on decoding performance being above a third threshold. Signaling information is sent to the second WTRU or set of second WTRUs, e.g. on the padding sequence structures used. A first set of symbols is constructed by appending the one or multiple padding sequences to a second set of complex modulated data symbols in a DFT-s-OFDM symbol. A DFT operation is performed on the first set of symbols to determine discrete frequency response on a first set of subcarriers. A subset of the subcarriers is punctured and the complex RS symbols are inserted at the locations of the punctured subcarriers in the frequency domain to obtain a second set of subcarriers. IFFT is performed on the second set of subcarriers and transmitting a DFT-s-OFDM symbol including data and RS.

Some implementations provide devices, methods and systems for post-DFT RS insertion with padding sequence adaptation. Information is received, in a RS configuration message, about the characteristics of the inserted RS, e.g. the RS sequence to use, its length, or a first subcarrier offset. A padding sequence structure indication is determined from a codebook based on a received indication through, e.g., a DCI in a PDCCH message. A DFT-s-OFDM symbol including data and RS is received. Interference from subcarrier puncturing and RS insertion is cancelled based on the determined padding sequence structure.

Some implementations provide devices, methods and systems for post-DFT RS insertion with padding sequence adaptation. Information is received, in a RS configuration message, about the characteristics of the inserted RS, e.g. the RS sequence to use, its length, or a first subcarrier offset. A padding sequence structure indication is determined from a codebook based on a received indication through, e.g., a DCI in a PDCCH message. A DFT-s-OFDM symbol is received which includes data and RS, and a quality indication is determined. The interference caused by RS insertion is cancelled based on the determined padding sequence structure. A quality indication is compared against a first threshold. Time-domain measurement of the maximum autocorrelation of the received signal is performed based on said quality indication being above a first threshold. Time-domain measurement of absolute magnitude of the interference on the received signal is performed based on said quality indication below a first threshold. A decoding performance, e.g., BLER, is detected. A codebook subset with lower PAPR is selected based on said maximum autocorrelation being above a second threshold, or said interference above a third threshold. A codebook subset with lower BLER is selected based on said decoding performance being above a fourth threshold. Feedback information, e.g., time-domain reporting messages or a padding sequence structure report, is transmitted.

Some implementations provide devices, methods and systems for pre-DFT RS insertion based on IFDMA. Information is received, in a RS configuration message, about the characteristics of the inserted RS, which may include the RS sequence to use, its length, or a first subcarrier offset. A first set of complex pilot symbols is determined by performing repetitions of an RS sequence one or more times. A first set of complex data symbol groups is generated by partitioning the complex modulated data symbols into one or more contiguous groups of symbols. A second set of complex data symbol groups is generated by performing repetitions of each group of symbols in the first set of complex data symbol groups one or more times. A second set of complex pilot symbols is generated by applying a first subcarrier offset to the first set of complex pilot symbols. A third set of complex data symbol groups is generated by applying a second set of subcarrier offsets to the second set of complex data symbol groups. A DFT operation is performed on the sum of the second set of complex pilot symbols and the third set of complex data symbol groups, to determine the discrete frequency response on a set of subcarriers. IFFT is performed on said set of subcarriers and transmitting a DFT-s-OFDM symbol including data and RS.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram which illustrates example pre-DFT and post-DFT insertion of RS in DFT-s-OFDM;

FIG. 3 is a diagram illustrating an example approach for post-DFT insertion using subcarrier interleaving;

FIG. 4 is a diagram illustrating example RS insertion by subcarrier puncturing through zero-padding;

FIG. 5 is a flow chart illustrating high-level procedures;

FIG. 6 is a flow chart illustrating a procedure where a transmitting node inserts pre-DFT RS based on Interleaved Frequency Division Multiple Access (IFDMA) multiplexing of RS and data;

FIG. 7 is a flowchart illustrating more detailed processing steps for pre-DFT RS insertion of pre-DFT RS based on IFDMA by the transmitting node;

FIG. 8 is a diagram which illustrates example multiplexing of RS and data in pre-DFT insertion based on IFDMA;

FIG. 9 is a flow chart illustrating data detection in pre-DFT RS insertion based on IFDMA by the receiving node;

FIG. 10 is a flow chart illustrating further detail with respect to FIG. 9;

FIG. 11 is a flowchart illustrating dynamic RS insertion at the BS side;

FIG. 12 is a flow chart illustrating processing at the BS side corresponding to the procedure shown and described with respect to FIG. 11;

FIG. 13 is a diagram illustrating sequence padding and permutation;

FIG. 14 is a flow chart illustrating detail of the DFT, subcarrier puncturing, and RS insertion;

FIG. 15 is a flow chart illustrating detail of further steps for generation of DFT-s-OFDM time-domain waveform;

FIG. 16 is a chart which further illustrates the feedback loop between BS and WTRU;

FIG. 17 is a flow chart illustrating example semi-static RS insertion at the BS side;

FIG. 18 is a flow chart illustrating example data detection and cancellation of interference from RS insertion at the WTRU side;

FIG. 19 is a block diagram which illustrates an example receive DFT-s-OFDM symbols step;

FIG. 20 is a flow chart illustrating dynamic RS insertion at the side;

FIG. 21 is a feedback loop illustrating the described signaling interaction between UE and BS as well as the transfer of uplink data from the UE to the BS;

FIG. 22 is a line graph which illustrates PAPR for 1 DM-RS symbol;

FIG. 23 is a line graph which illustrates PAPR for 4 DM-RS symbols;

FIG. 24 is a line graph illustrating BER for 1 DM-RS symbol, AWGN;

FIG. 25 is a line graph illustrating BER for 4 DM-RS symbols, AWGN;

FIG. 26 is a line graph illustrating BER for 1 DM-RS symbol, Rayleigh;

FIG. 27 is a line graph illustrating BER for 4 DM-RS symbol, Rayleigh;

FIG. 28 is a flow chart illustrating an example implementation relating to detection of shared DFT-s-OFDM symbols with pre-DFT insertion of RS based on IFDMA;

FIG. 29 is a flow chart illustrating an example implementation relating to transmission of shared DFT-s-OFDM symbols with post-DFT insertion of RS based on padding sequence adaptation without feedback;

FIG. 30 is a flow chart illustrating an example implementation relating to transmission of shared DFT-s-OFDM symbols with post-DFT insertion of RS based on padding sequence adaptation with feedback;

FIG. 31 is a flow chart illustrating an example implementation relating to detection of shared DFT-s-OFDM symbols with post-DFT insertion of RS based on padding sequence adaptation without feedback;

FIG. 32 is a flow chart illustrating an example implementation relating to detection of shared DFT-s-OFDM symbols with post-DFT insertion of RS based on padding sequence adaptation with feedback; and

FIG. 33 is a flow chart illustrating a simplified procedure for detection of shared DFT-s-OFDM symbols with post-DFT insertion of RS based on padding sequence adaptation with feedback.

### DETAILED DESCRIPTION

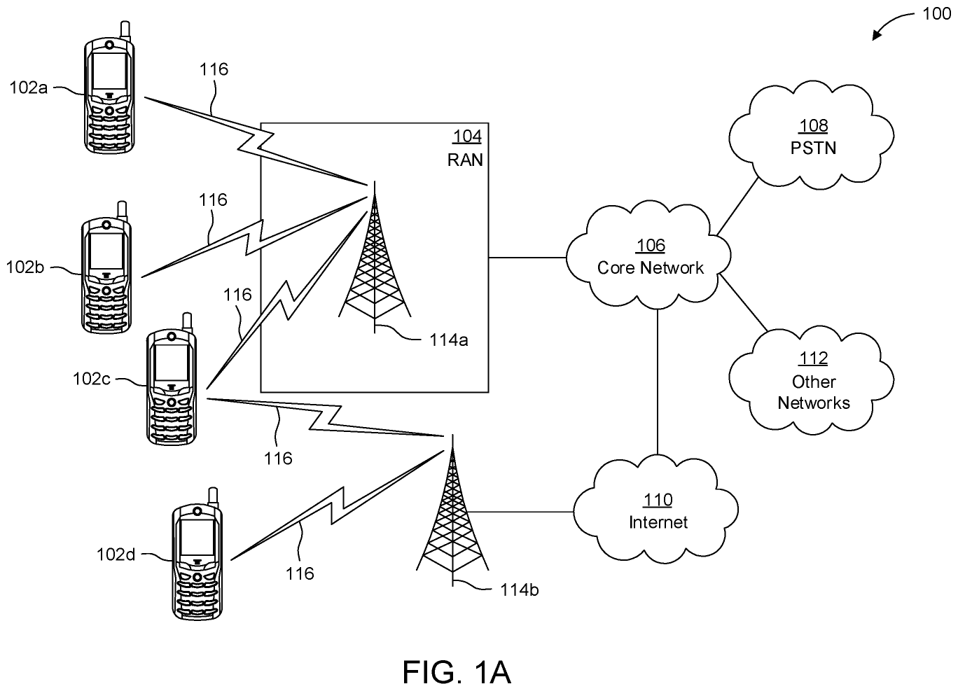

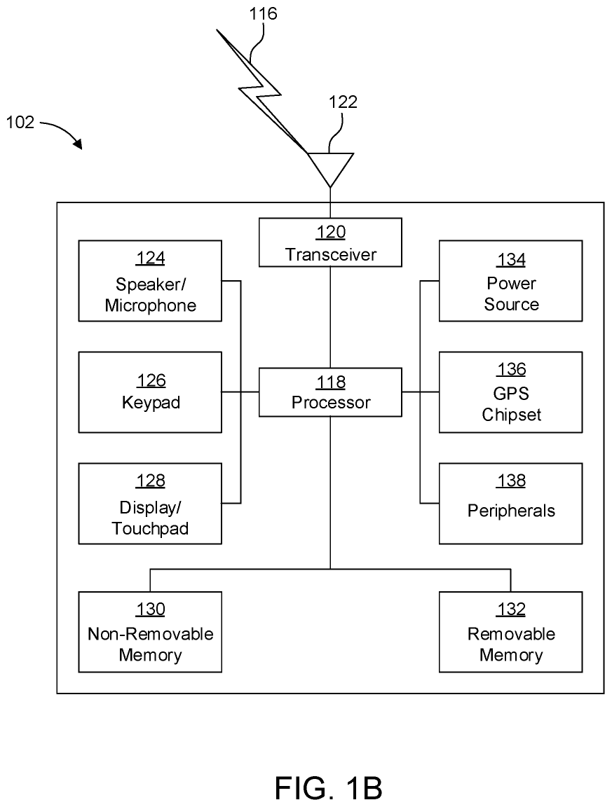

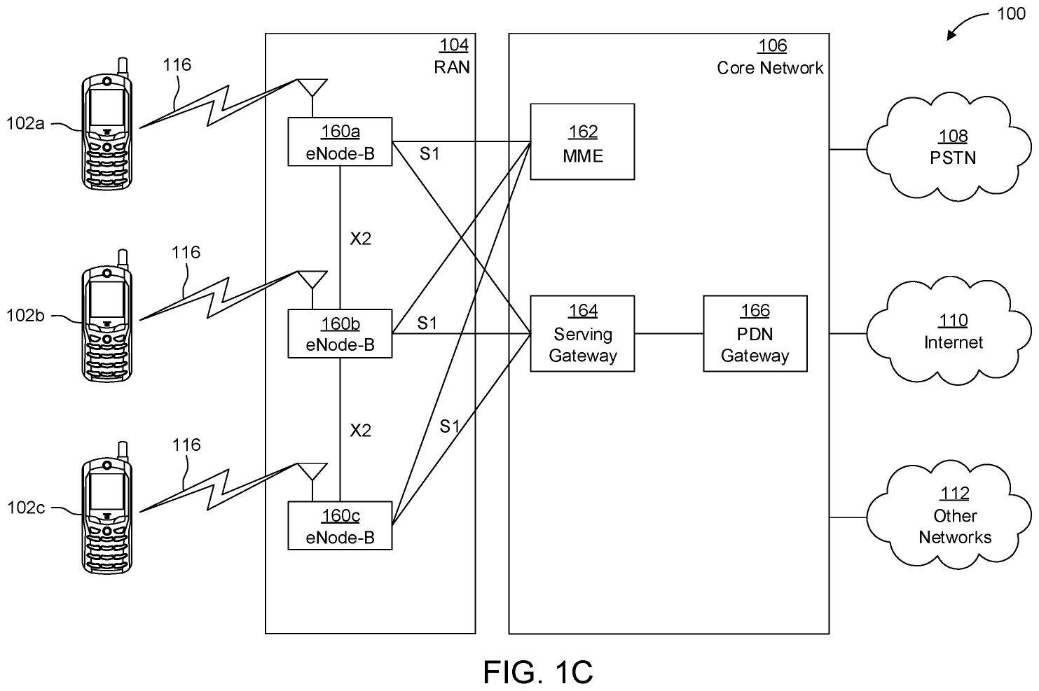

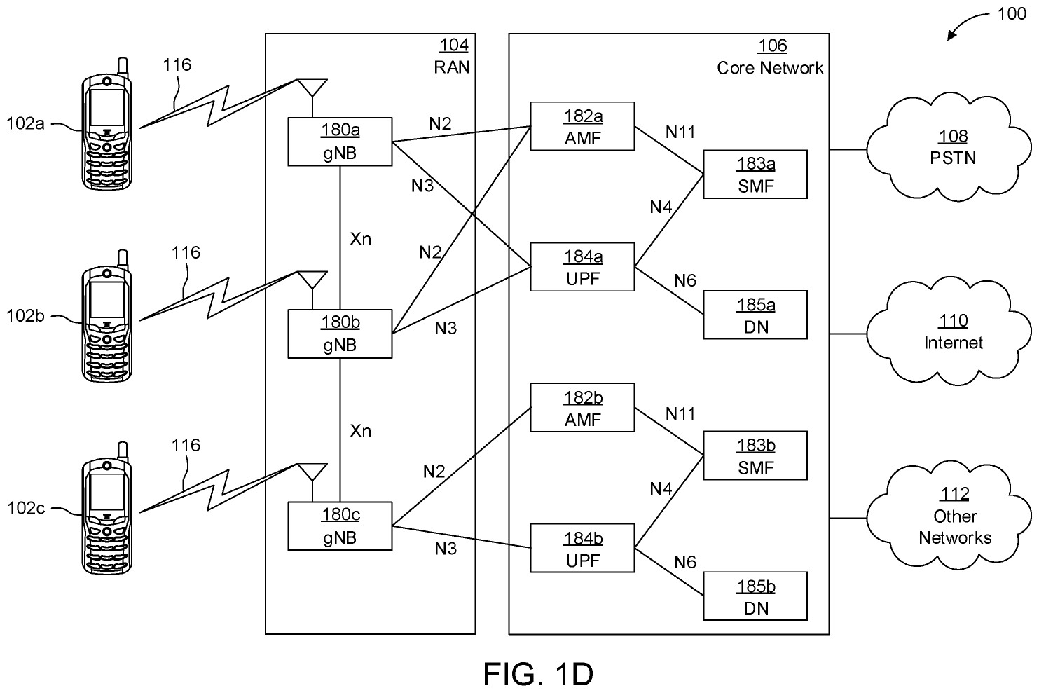

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles.

Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b. 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms, among others are used herein:

| | |
|---|---|
| 3GPP | Third Generation Partnership Project |
| 4G | 4^{th} Generation |
| 5G | 5^{th} Generation |
| 16QAM | 16 - Quadrature Amplitude Modulation |
| 64QAM | 64 - Quadrature Amplitude Modulation |
| AWGN | Additive White Gaussian Noise |
| BER | Bit Error Rate |
| BLER | Block Error Rate |
| BS | Base Station |
| CCDF | Complementary Cumulative Distribution Function |
| CP | Cyclic Prefix |
| CP-OFDM | Cyclic Prefix - Orthogonal Frequency Division |
| | Multiplexing |
| DCI | Downlink Control Indicator |
| DFT | Discrete Fourier Transform |
| DFT-s-OFDM | Discrete Fourier Transform - spread - Orthogonal |
| | Frequency Division Multiplexing |
| DL | Downlink |
| DM-RS | Demodulation Reference Signal |
| Eb/N0 | Bit Energy over Noise Spectral Density |
| FEC | Forward Error Correction |
| FFT | Fast Fourier Transform |
| FR2 | Frequency Range 2 |
| IDFT | Inverse Discrete Fourier Transform |
| IFDMA | Interleaved Frequency Division Multiple Access |
| IFFT | Inverse Fast Fourier Transform |
| ISI | Inter-Symbol Interference |
| LMMSE | Linear Minimum Mean Squared Error |
| LTE | Long Term Evolution |
| MAC CE | Medium Access Control - Control Element |
| MIMO | Multiple Input Multiple Output |
| ML | Machine Learning |
| MSE | Mean Squared Error |
| ML | Maximum Likelihood |
| MU-MIMO | Multi-User Multiple Input Multiple Output |
| NLOS | Non-Line of Sight |
| NR | New Radio |
| OFDM | Orthogonal Frequency Division Multiplexing |
| PA | Power Amplifier |
| P/S | Parallel to Serial |
| PAPR | Peak to Average Power Ratio |
| PDCCH | Physical Downlink Control Channel |
| PSeqS | Padding Sequence Structure |
| PSeqS ID | Padding Sequence Structure Identifier |
| PT-RS | Phase Tracking Reference Signal |
| PUCCH | Physical Uplink Control Channel |
| PUSCH | Physical Uplink Shared Channel |
| QPSK | Quadrature Phase Shift Keying |
| RRC | Radio Resource Control |
| RNTI | Radio Network Temporary Identifier |
| RS | Reference Signal |
| SIC | Successive Interference Cancellation |
| S/P | Serial to Parallel |
| SNR | Signal to Noise Ratio |
| SU-MIMO | Single-User Multiple Input Multiple Output |
| TDL | Tapped Delay Line |
| TRP | Transmit-Receive Point |
| UCI | Uplink Control Indicator |
| UE | User Equipment |
| UL | Uplink |
| WTRU | Wireless Transmit/Receive Unit |

Discrete Fourier Transform-spread Orthogonal Frequency Division Multiplexing (DFT-s-OFDM) is a single-carrier waveform, e.g., as adopted by Third Generation Partnership Project (3GPP) for the uplink of 4G Long-Term Evolution (LTE) and 5G New Radio (NR) wireless cellular standards.

Unlike other multicarrier waveforms like Cyclic Prefix-Orthogonal Frequency Division Multiplexing (CP-OFDM), the single-carrier nature of DFT-s-OFDM may allow a reduced peak-to-average power ratio (PAPR) while retaining other benefits of CP-OFDM, such as DFT-based frequency-domain equalization and simple inter-symbol interference (ISI) mitigation. The efficiency of the power amplifiers (PA) may improve with a reduced PAPR because the range of output powers where the device keeps a linear response may be larger, delivering higher output power for the same PA technology. This property may be especially relevant when carrier frequencies are increased beyond Frequency Range 2 (FR2), i.e., above 52.6 GHZ, as PA efficiency starts to shrink dramatically at these higher frequencies.

DFT-s-OFDM may be basically characterized by a Transform Precoding stage added to the normal processing steps in CP-OFDM. In some implementations, transform precoding may achieve a single-carrier waveform in the time domain only if subcarriers are mapped to contiguous frequency positions, which may limit the flexibility of DFT-s-OFDM to allocate control and data information in the frequency domain. In some implementations, for this reason, control and data channels in 5G NR, in some implementations, are not multiplexed in frequency but are allocated different DFT-s-OFDM symbols so that the single-carrier nature is preserved. This may also be applicable to some 5G NR Reference Signals (RS), such as DM-RS, which does not allow multiplexing of data information in the same symbol.

In some implementations, state-of-the-art insertion of RS in DFT-s-OFDM may be categorized in either of two mechanisms: pre-DFT or post-DFT. In some implementations, RS insertion in 5G NR falls in the pre-DFT category.

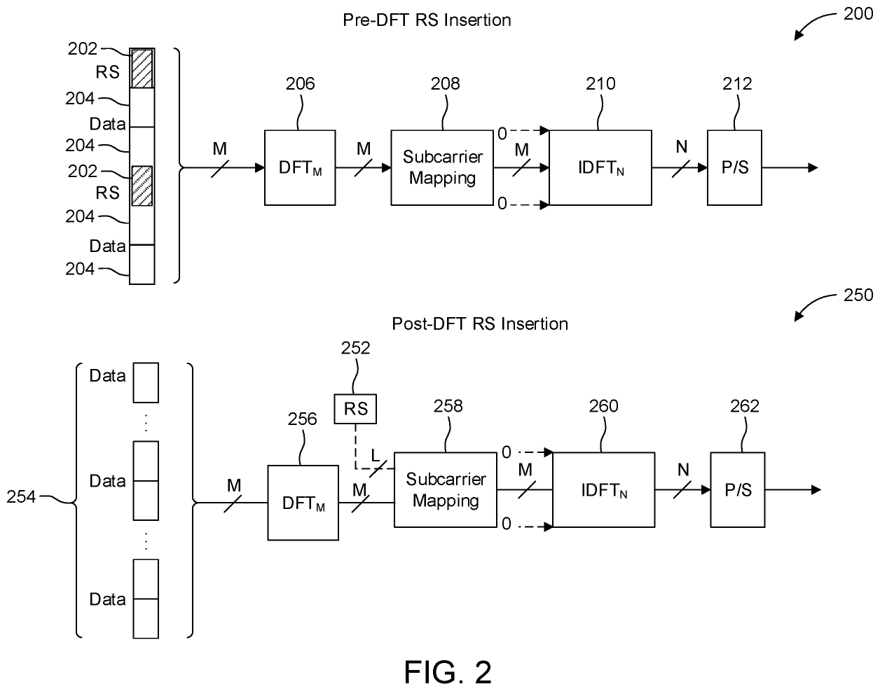

FIG. 2 is a diagram which illustrates example pre-DFT insertion 200 of RS 202 in DFT-s-OFDM and post-DFT insertion 250 of RS 252 in DFT-s-OFDM.

Pre-DFT insertion 200 includes at least one RS 202 inserted into data 204 prior to applying DFT 206. In pre-DFT insertion 200, RS symbols 202 are inserted into data 204 before the DFT 206 in 5G NR.

In some implementations, when inserted before DFT, RS symbols 202 are either multiplexed with data 204 in the time domain or mapped alone in the data 204 symbol (i.e., not multiplexed with any other data symbols), before Transform Precoding (i.e., before DFT 206, e.g., as set out in 5G NR standards) subcarrier mapping 208, inverse DFT (IDFT) 210, and parallel/serial conversion (P/S) 212.

In some implementations, subcarriers are mapped to contiguous frequency positions to preserve the single-carrier nature of the waveform, and frequency-multiplexing of control and data information is not possible.

In some implementations, 5G NR Demodulation Reference Signals (DM-RS), may be mapped alone in the symbol (i.e., not multiplexed with any other data symbols) and may occupy up to four complete symbols per sl) ot in DFT-s-OFDM. In some implementations, data information is not frequency-multiplexed in those symbols, which may lead to inefficiencies, e.g., due to high resource utilization of the control signals, e.g., when more than one DM-RS symbol per slot is used. In some implementations, increasing the number of DM-RS symbols beyond one may be needed, e.g., at frequencies beyond 52.6 GHZ, e.g., to effectively track Doppler variations at the higher modulations. In some implementations, in such cases, the overhead from DM-RS may be relatively quite high.

In some implementations, 5G NR Phase-Tracking Reference Signals (PT-RS), may be multiplexed with data in the time domain before the DFT. In some implementations, unlike DM-RS, PT-RS symbols are multiplexed with data prior to the DFT and the resource utilization can be adjusted based on needs. However, in some implementations, the DFT operation spreads both data and PT-RS over the output subcarriers which may make it not possible to multiplex data and control information in the frequency domain.

In some implementations, pre-DFT RS insertion in 5G NR may therefore be limited to the generation of either contiguous RS in the frequency domain (e.g., with poor resource utilization) or RS multiplexed with data in the time domain (e.g., not able to be interleaved with data in the frequency domain).

Accordingly, some implementations relate to post-DFT insertion of reference signals in DFT-s-OFDM.

In post-DFT insertion 250, at least one RS 252 is inserted into data 254 after applying DFT 256.

In some implementations, when inserted after DFT, RS symbols 252 are inserted after DFT 256, and before subcarrier mapping 258, IDFT 260, and PS 262.

When inserted after DFT, in some implementations, RS symbols may be multiplexed with data at whatever frequency locations are needed. In some implementations, the contiguous allocation of data subcarriers in the frequency domain is no longer preserved and PAPR will increase compared to the case with no RS inserted, but resource efficiency may be higher than in pre-DFT insertion by allocating only the RS symbols that are needed.

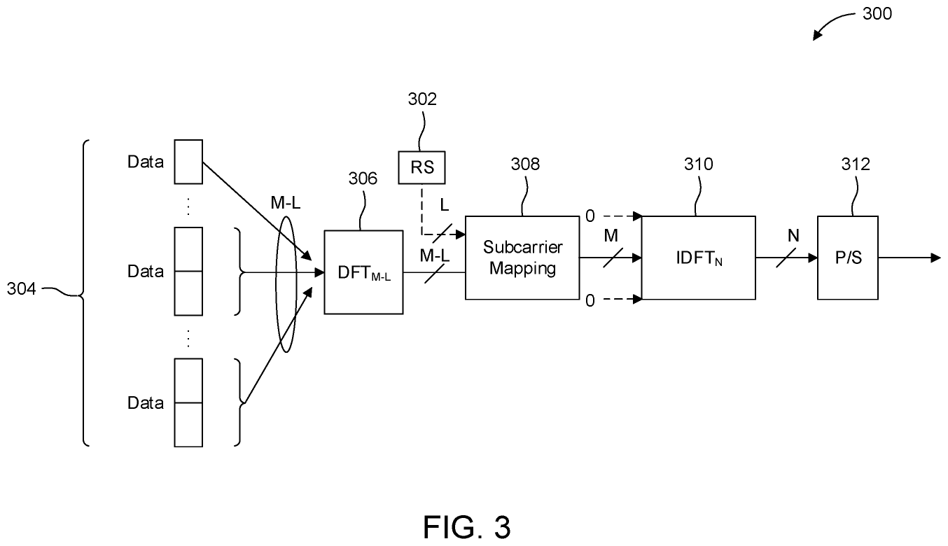

Some implementations include interleaved RS insertion and subcarrier puncturing techniques for post-DFT insertion. For example, some implementations relate to interleaved RS insertion. FIG. 3 is a diagram illustrating an example post-DFT insertion 300 using subcarrier interleaving.

In this example, L reference symbols 302 are inserted in a distributed manner within a block of M contiguous subcarriers and multiplexed with (M-L) modulated data symbols. An (M-L)-point DFT 306 is be performed over data 304 and its output can be mapped to non-contiguous frequency positions in subcarrier mapping 308, (prior to IDFT 310 and P/S 312) thus leaving space for further allocation of L reference symbols in interleaved form. In some implementations, L reference symbols 302 and (M-L) data symbols 304 are in this way effectively interleaved in M subcarriers.

In some implementations, this procedure may be suited to the insertion of distributed RS at non-periodic locations in the frequency domain. However, in some implementations, this may have the drawback of forcing the transceiver to employ different DFT sizes for DFT-s-OFDM symbols carrying RS (M-L) and not carrying RS (M), hence complicating implementations. Further, in some implementations, both (M-L) and M must comply with the allowed DFT sizes in 3GPP LTE and NR, namely {2^{a}·3^{b}·5^{c}, a, b, c∈ [symbol] }, which may limit the standards evolution towards the use of different RS frequency densities. As an example, in some implementations, frequency densities of e.g., one eighth of the resource elements would not be allowed for an RS signal, as

$$M - L = \frac{7}{8} M$$

does not comply with me formula regardless of the value of M. Further, in some implementations, this technique does not offer any possibility to control PAPR.

The complexity, measured by the number of complex multiplications and not considering the equalization step (common to all techniques), is given by (M−L) log₂ (M−L).

Some implementations relate to RS insertion by subcarrier puncturing. In some implementations, to overcome the above-described issues, using the same DFT size in all DFT-s-OFDM symbols may be more appealing for post-DFT insertion of RS.

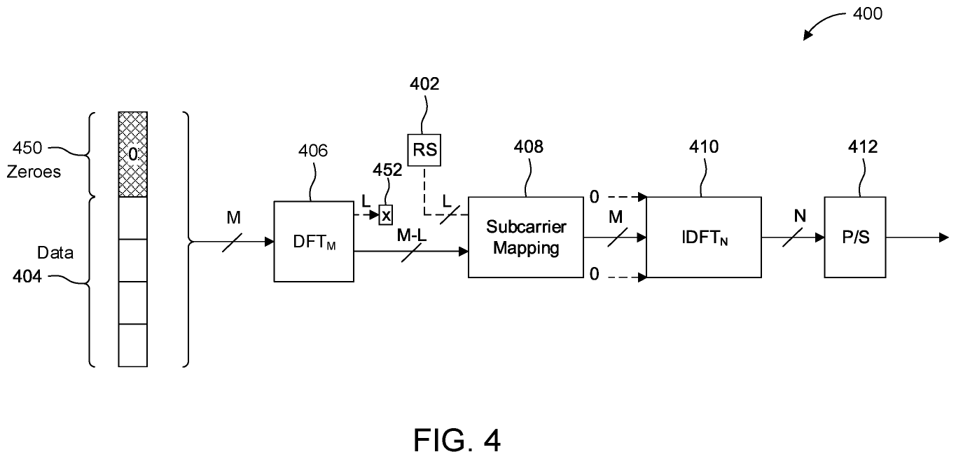

FIG. 4 is a diagram illustrating an example procedure 400 for RS insertion by subcarrier puncturing through zero-padding, where data symbols 404 are padded with zeroes 450 up to size M and an M-point DFT 406 is performed, after which L data subcarriers 452 are punctured at the output of the DFT 406 stage and RS symbols 402 are inserted after DFT 406, and before subcarrier mapping 408, IDFT 410, and PS 412.

In some implementations, this procedure may be suited to the insertion of distributed RS at periodic locations in the frequency domain. In such cases, subcarrier puncturing may lead to some interference that appears in the DFT-s-OFDM time-domain signal in the form of a periodic term, as a consequence of the periodic locations of the RS subcarriers, and in some implementations, is compensated at reception before demodulating the data symbols. In some implementations, such interference term may produce an increase in both bit error rate (BER) statistics and PAPR. In some implementations, the increase in PAPR due to the interference term is added to the PAPR increase caused by RS insertion as a result of the non-contiguity of data subcarriers after DFT. In some implementations, PAPR increase may be harmful in multi-user scenarios based on DFT-s-OFDM where each user is allocated a different cluster of subcarriers in the frequency domain, e.g., because the PAPR of multi-clustered transmissions may worsen as the dynamic load of the network increases.

Some techniques for post-DFT insertion based on subcarrier puncturing may rely on the receiver to perform interference mitigation for data recovery and do not provide any means to reduce PAPR.

In some implementations, inserting distributed RS patterns in the frequency domain may present several benefits compared to block RS patterns. For example, distributed RS patterns have higher efficiency of resource utilization compared to the block RS patterns in pre-DFT RS insertion, e.g., as evident in 5G NR DM-RS for PUCCH Format 3 with an overhead up to 50%. Further, distributed RS may have the advantage of providing more flexibility than block RS to allocate Multiple Input/Multiple Output (MIMO) orthogonal layers. In Multi-User (MU)-MIMO, the use of hybrid beamforming at high frequencies may require digital precoding to spatially multiplex the signals when beams overlap in space. In Single-User (SU)-MIMO, future device evolution might lead to an increased number of supported MIMO layers. In both cases, DM-RS signals can be more flexibly mapped to resources when allocated in the frequency domain.

Current LTE and NR wireless cellular systems using DFT-s-OFDM only contemplate pre-DFT insertion of RS based on either occupying a full OFDM symbol resource allocation (with poor resource utilization) or multiplexing with data signals in the time domain (not able to be interleaved with data in the frequency domain), in order not to impair the single carrier waveform's low PAPR.

Future use of post-DFT insertion of RS as an alternative solution to avoiding the spectral inefficiencies associated with the use of pre-DFT insertion of RS may implicate various drawbacks of post-DFT insertion of RS described herein. Accordingly, it may be desired to address potential challenges of post-DFT insertion based on interleaved RS insertion, such as increased PAPR, restrictions in the attainable RS frequency patterns, and use of different DFT sizes for symbols carrying and not carrying RS.

Further, it may be desired to address potential challenges of RS insertion by subcarrier puncturing, such as where RS insertion by subcarrier puncturing through zero padding does not provide any ability to control PAPR and performance other than through optimized receiver structures.

Some implementations provide an adaptive framework for pre-DFT and post-DFT insertion of distributed RS in DFT-s-OFDM at periodic locations in the frequency domain, e.g., to provide flexibility of RS frequency patterns while providing means to minimize PAPR and optimize demodulation performance. Further, some implementations provide WTRU assistance, for example in terms of UE capability signaling, measurements in support of a more efficient power allocation scheme, and/or feedback to base station decisions.

As used herein, it is assumed that L reference symbols (or pilots) are to be inserted in a distributed manner over a block of M contiguous subcarriers and multiplexed with (M-L) modulated data symbols {d[0], . . . , d[M−L−1]}. Pilots may be a-priori known complex values or blank symbols depending on the application.

Pilots may be inserted at regulary spaced subcarrier positions

$$\{ k \frac{M}{L} + p , k = 0 , ... , L - 1 \} ,$$

where p may be any integer of the set

$$p ∈ \{ 0 , ... , \frac{M}{L} - 1 \}$$

and represents an a-priori known frequency shift. Combined frequency patterns are also possible in the form

$$\{ {k}_{1} \frac{M}{L} + {p}_{1} , {k}_{1} = 0 , ... , L - 1 \} , \{ {k}_{2} \frac{M}{L} + {p}_{2} , {k}_{2} = 0 , ... , L - 1 \}$$

with two a-priori known frequency shifts

$${p}_{1} , {p}_{2} ∈ \{ 0 , ... , \frac{M}{L} - 1 \} \cdot ( M - L )$$

will be a multiple of L.

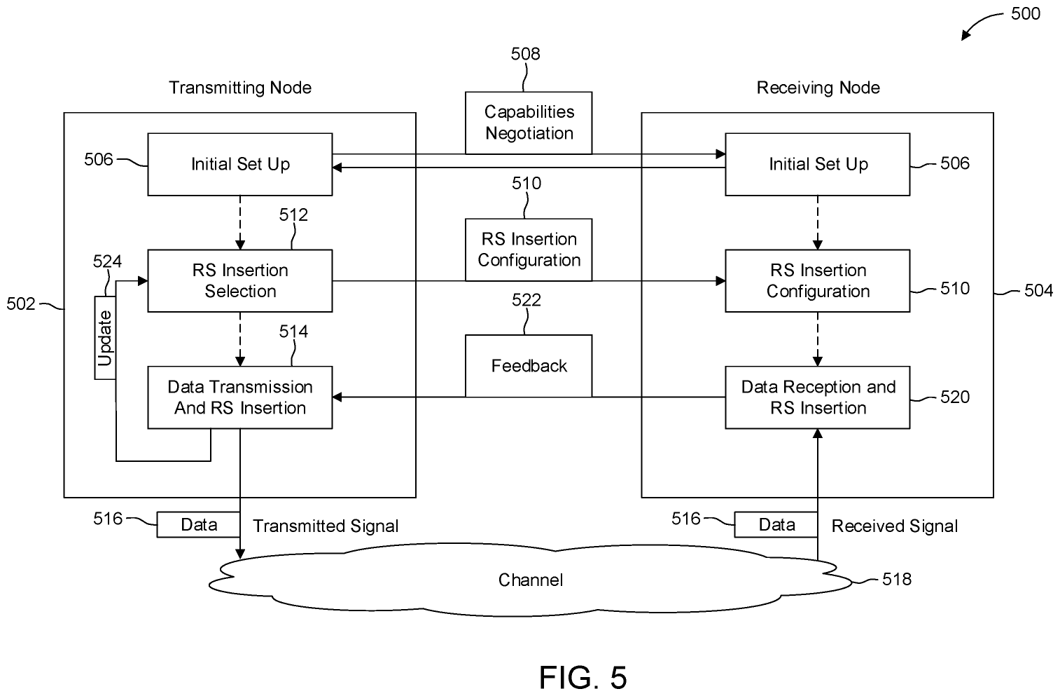

FIG. 5 is a flow chart illustrating high-level procedures 500, which are further illustrated in more detail with respect to exemplary implementations herein. In the example of FIG. 5, a transmitting node 502 and a receiving node 504 may first exchange information, e.g., as a part of initial setup 506 and capabilities negotiation 508. The information may include, without limitation, any one or more of the following elements which may relate to and/or indicate their RS insertion capabilities: support for pre-DFT RS insertion; support for post-DFT RS insertion based on IFDMA; support for RS insertion based on subcarrier puncturing via padding sequences, and the supported padding sequence structures; support for fixed or adaptive RS sequences, and the RS sequences supported in the adaptive case; PA-related information, like e.g. PA type/class or PAPR requirement/preference; and/or demodulation-related information, like e.g. support of SIC with a maximum number of iterations, or any other detection-related parameter.

In some implementations, after the initial set up 506 is complete, the transmitting node may provide the receiving node with RS insertion configuration parameters 510, e.g., via DCI-related signaling, or MAC CE. RS insertion configuration parameters 510 may include information indicating, e.g., RS insertion type, padding sequence structure detection mode (e.g., blind vs. explicit), padding sequence structure identifier, or any other information required by the RS insertion technique. In some implementations, the RS insertion type may be dynamically selected, e.g., by transmitting node 502 during RS insertion selection 512, from among any one or more of several options, such as the following: pre-DFT RS insertion of full RS symbols, pre-DFT RS insertion based on IFDMA, post-DFT RS insertion based on padding sequence adaptation, post-DFT RS insertion with RS sequence adaptation, and/or post-DFT RS insertion based on padding sequence adaptation and RS sequence adaptation. In some implementations, the transmitting node 502 may decide to switch among these alternatives, e.g., based on available transmit power, PAPR, complexity, and/or on feedback reports and/or signaling information obtained from the receiving node 504 (which may include, e.g., information about demodulation performance, PAPR measurements, capabilities information, preferred RS insertion type, preferred padding sequence structure type, and/or a similar indication).

After RS insertion 514, data 516 may be transmitted from the transmitting node 502 to the receiving node, e.g., over a suitable channel 518.

In some implementations, after data transmission and RS insertion 514, the receiving node 504 performs data reception 520 and provides feedback 522, e.g., in an event, triggered, or periodic fashion, in order to aid the transmitting node 502 in the selection of the most suitable RS insertion technique to use for the receiving node 504.

In some implementations, the transmitting node 502 may also dynamically update 524 some or all of the configuration parameters related with RS insertion, e.g., based on and/or in response to feedback 522 from receiving node 504, such as e.g., padding sequence structure identifier, RS sequence type, or any other suitable feedback.

Various RS insertion techniques, e.g., usable with the implementation shown and described with respect to FIG. 5, are described herein, e.g., with respect to various example implementations.

Some implementations relate to pre-DFT RS insertion based on IFDMA. For example, some implementations include pre-DFT insertion of RS based on suitable multiplexing of the data and RS symbols in an interleaved fashion before the DFT stage. Some implementations include insertion of distributed RS by the transmitting node.

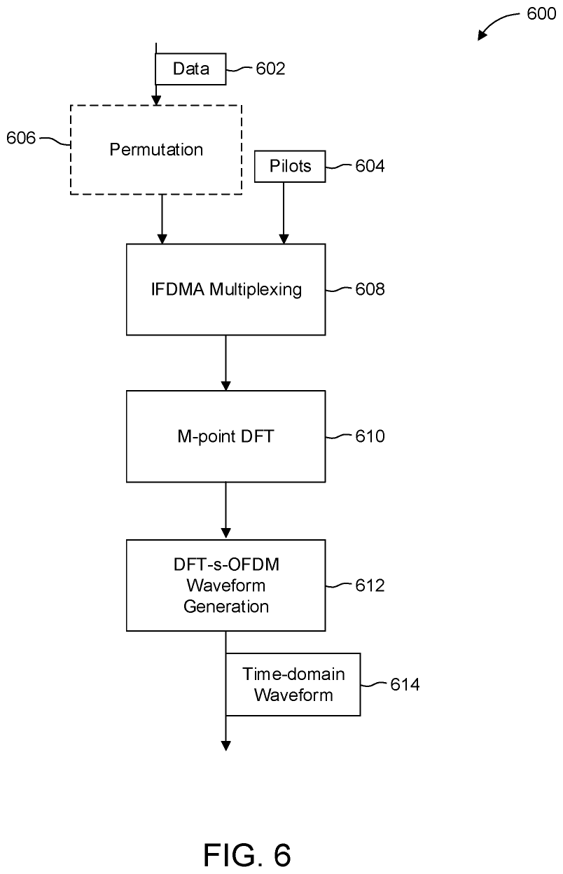

FIG. 6 is a flow chart illustrating a procedure 600 where a transmitting node inserts pre-DFT RS based on Interleaved Frequency Division Multiple Access (IFDMA) multiplexing of RS and data 602. A vector of time-domain pilots 604 is created by concatenating M/L repetitions of the L RS symbols and further applying a frequency shift of p subcarriers. A permutation 606 is optionally applied over the complex modulated data symbols, and the result is partitioned into contiguous sets of L symbols wherein each set is frequency-shifted by a number of subcarriers that shall be different than the pilot frequency shift p, and lower than L. The frequency-shifted pilots are summed together with the frequency-shifted complex modulated data symbols via IFDMA multiplexing 608, and an M-point DFT 610 is performed. Standard DFT-s-OFDM processing 612 follows to generate the time-domain waveform 614.

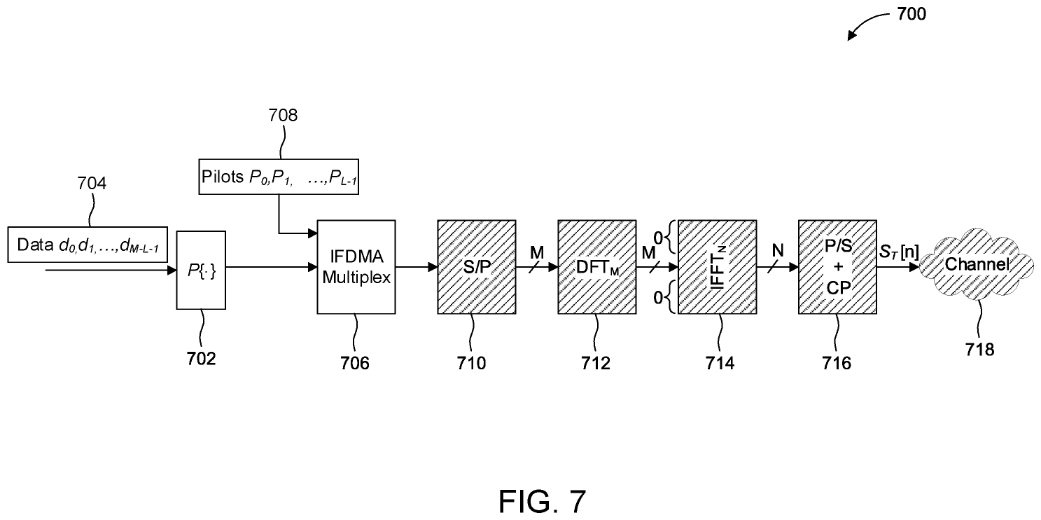

FIG. 7 is a flowchart illustrating more detailed processing steps for pre-DFT RS insertion of pre-DFT RS based on IFDMA by the transmitting node, e.g., corresponding to the steps shown and described with respect to FIG. 6.

In this example, the transmitting node first applies an optional permutation [symbol] {·} 702 over data symbols d 704 to provide the lowest possible autocorrelation of the permuted time-domain symbols \tilde{d} [symbol] [symbol] {d} at time instants other than zero. IFDMA multiplexing 706 then creates the pilot vector p̅∈ [symbol] with components

$${\overline{p}}_{i} = {p}_{imodL} {e}^{j 2 π pi / M} , i = 0 , ... , M - 1 ,$$

where {pᵢ, i=0, . . . , L−1} denotes the time-domain complex pilot symbols 708, and then the data vector d̅^{l} with components as in the following equation:

$${\overline{d}}_{i}^{l} = {\tilde{d}}_{( imodL + lL )} {e}^{j 2 π {k}_{l} i / M} , i = 0 , ... , M - 1 , l = 0 , ... , \frac{M - L}{L} - 1$$

where kₗ are elements of the set

$$\{ 0 , ... , \frac{M}{L} - 1 \}$$

so that kₗ≠p to ensure that there is no overlap between pilots 708 and data 704. Then the vector s is created as the sum of pilots 708 and data 704, as in the following equation:

$$s = \overline{p} + {\sum }_{l = 0}^{\frac{M}{L} - 2} {\overline{d}}^{l}$$

after which the transmitting node applies S/P 710, DFT 712, IFFT 714, then P/S and CP 716 to generate st[n] (the time-domain signal) for transmission over a channel 718.

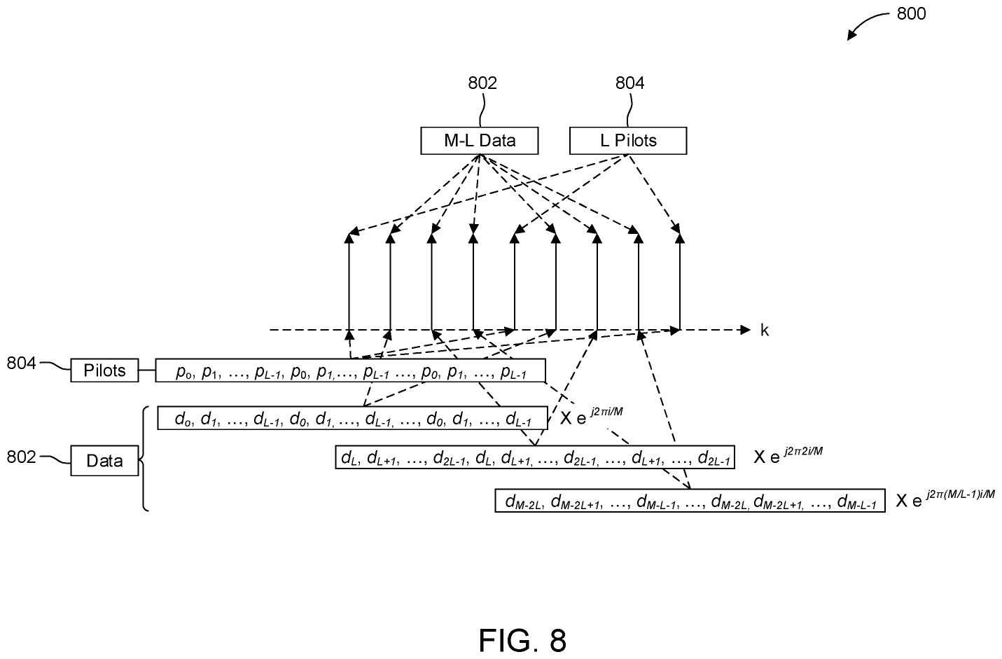

FIG. 8 is a diagram which illustrates example multiplexing 800 of RS 804 (pilots) and data 802 in pre-DFT insertion based on IFDMA. In FIG. 8, k is a subcarrier index value in the frequency domain, and i is the sample value in the time domain. FIG. 8 illustrates an example arrangement of RS 802 (pilots) and data 802 that may be implemented, e.g., as IFDMA multiplexing block 608 as shown and described with respect to FIG. 6. After the multiplexing 800 shown in FIG. 8, an M-point DFT may be applied on vector s (the output of FIG. 8) and standard DFT-s-OFDM processing follows to generate a time-domain signal which includes the data and distributed RS. Multiple signals may be multiplexed in frequency as in standard DFT-s-OFDM by simply including them as inputs to the N-point IFFT block shown and described with respect to FIG. 7, e.g., at the appropriate center subcarriers.

Some implementations relate to data detection by the receiving node.

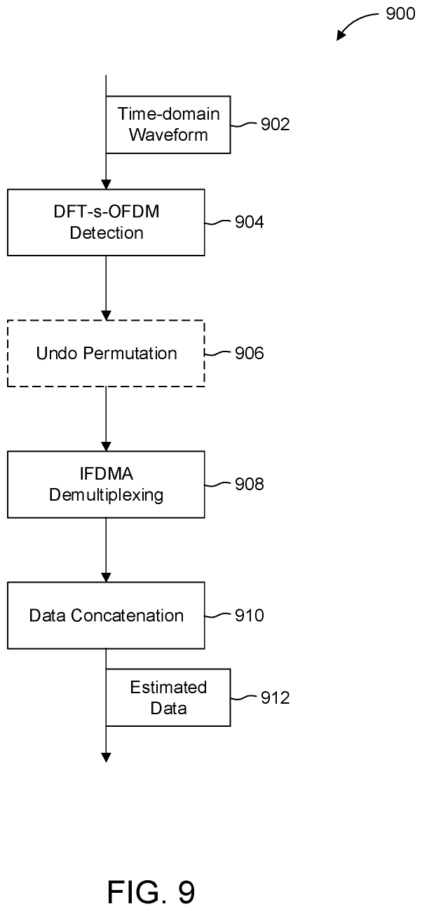

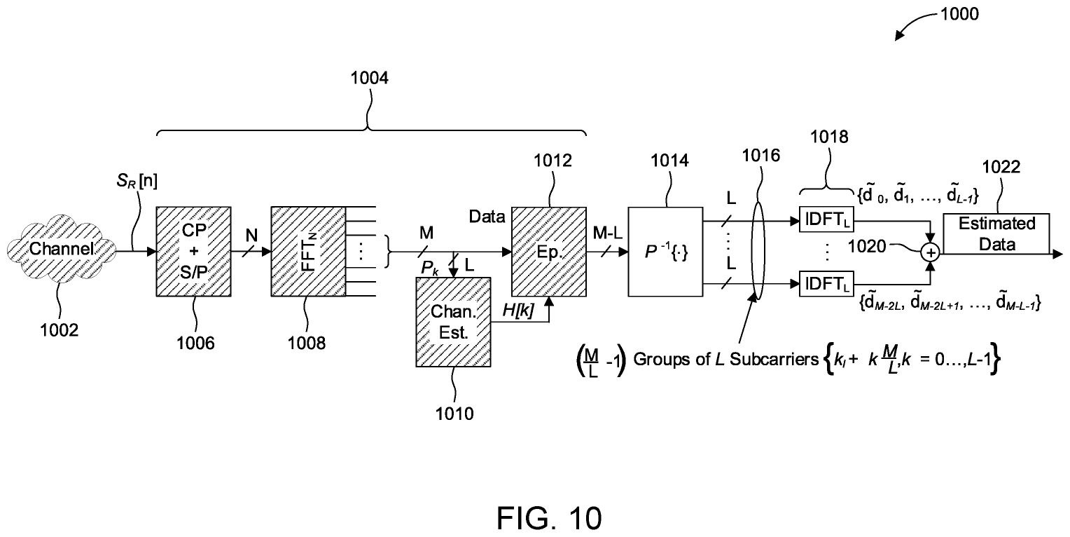

FIG. 9 is a flow chart illustrating an example process 900 for data detection in pre-DFT RS insertion based on IFDMA by the receiving node. In the example of FIG. 9, the receiving node performs the following steps for data detection. The processing steps shown an described with respect to FIG. 9 are further detailed in FIG. 10, which is a flow chart illustrating receiving node processing steps for data detection in pre-DFT RS insertion based on IFDMA.

In the example of FIG. 9, the receiver demodulates the DFT-s-OFDM symbols and performs channel estimation and equalization of time domain waveform 902 in step 904 to yield complex multiplexed data and pilot symbols.

In some implementations, the permutation step is undone in step 906, and thereafter a set of parallel L-point IDFTs can be performed over the sets of data symbols in step 908, after which the sets of data symbols are concatenated in step 910 to yield the estimated data, 912. Alternatively, in some implementations, a single DFT is performed to recover the interleaved data according to prior art techniques. In this context, undoing the permutation in step 906 refers to performing an inverse permutation operation, i.e., an operation described by the mathematical inverse of the permutation operation performed by the transmitting node.

FIG. 10 is a flow chart of an example process 1000 for receiving node processing steps for data detection in pre-DFT RS insertion based on IFDMA in the receiving node. Process corresponds essentially to example process 900 as shown and described with respect to FIG. 10, in further detail. In some implementations, the receiver receives time-domain received waveform SR[n] from channel 1002 and performs DFT-s-OFDM demodulation blocks 1004 (e.g., reverse CP and S/P in step 1006, FFT in step 1008, and channel estimation 1010 and equalization 1012 of time domain waveform). The permutation is undone in step 1014. In some implementations, subcarriers are then de-interleaved in step 1016. e.g., by picking the

$$( \frac{M}{L} - 1 )$$

groups of L subcarriers with indices

$$\{ {k}_{l} + k \frac{M}{L} , k = 0 , ... , L - 1 \} ,$$

where

$${k}_{l} ∈ \{ 0 , ... , \frac{M}{L} - 1 \}$$

and kₗ≠p.

In some implementations the groups of subcarriers may undergo a set of

$$( \frac{M}{L} - 1 )$$

parallel L-point IDFTs in step 1018, yielding

$$( \frac{M}{L} - 1 )$$

sets of L complex symbols that include the data previously segmented at the transmit side: {\tilde{d}₀, \tilde{d}₁, . . . , \tilde{d}_{L-1}}, {\tilde{d}₁, \tilde{d}₁₊₁, . . . , \tilde{d}_{2L-1}}, . . . , {\tilde{d}_{M-2L}, \tilde{d}_{M-2L+1}, . . . , \tilde{d}_{M-L-1}] where \tilde{d}ᵢ represent the complex estimated data symbols after equalization, i=0, . . . , M−L−1. In some implementations, the segments are concatenated in step 1020 to deliver the received estimated data block 1022 as in the following expression:

$$\{ {\tilde{d}}_{0} , {\tilde{d}}_{1} , ... , {\tilde{d}}_{L - 1} , {\tilde{d}}_{L} , {\tilde{d}}_{L + 1} , ... , {\tilde{d}}_{2 L - 1} , ... , {\tilde{d}}_{M - 2 L} , {\tilde{d}}_{M - 2 L + 1} , ... , {\tilde{d}}_{M - L - 1} \} .$$

Alternatively, in some implementations, the receiver may perform a single DFT to recover the interleaved data according to prior art techniques.

The complexity [symbol] _{IFDMA} in terms of complex multipliers of the detection procedure after the equalization step (common to prior art techniques) may be described as given below. Assuming first that the detection procedure is based on

$$( \frac{M}{L} - 1 )$$

parallel L-point IDFTs, and not considering permutation, the complexity may be given by the following equation:

$${IFDMA}_{} = ( \frac{M}{L} - 1 ) L {log}_{2} L = ( M - L ) {log}_{2} L$$

This complexity is lower or equal than the complexity of the interleaved RS insertion described earlier. As in that case, requiring L-point DFTs forces the hardware to perform DFT size adaptation depending on the presence of RS in the symbol. An alternative technique based on a single M-point IDFT is more convenient and has a complexity given by the following equation:

$${IFDMA}_{} = \frac{1}{2} M {log}_{2} M$$

Here, advantageously, a single DFT size M is needed for all DFT-s-OFDM symbols.

Some implementations relate to post-DFT RS Insertion based on Padding Sequence Adaptation. Such implementations may include post-DFT RS insertion techniques based on subcarrier puncturing and selection of suitable padding sequence structure or structures to append to the data symbols before the DFT stage. Such implementations may be referred to based on the type of transmitting node (e.g., base station or user equipment) and the type of padding sequence adaptation (e.g., dynamic or semi-static).

Some implementations include Dynamic insertion of distributed RS by the Base Station aided by User Equipment feedback.

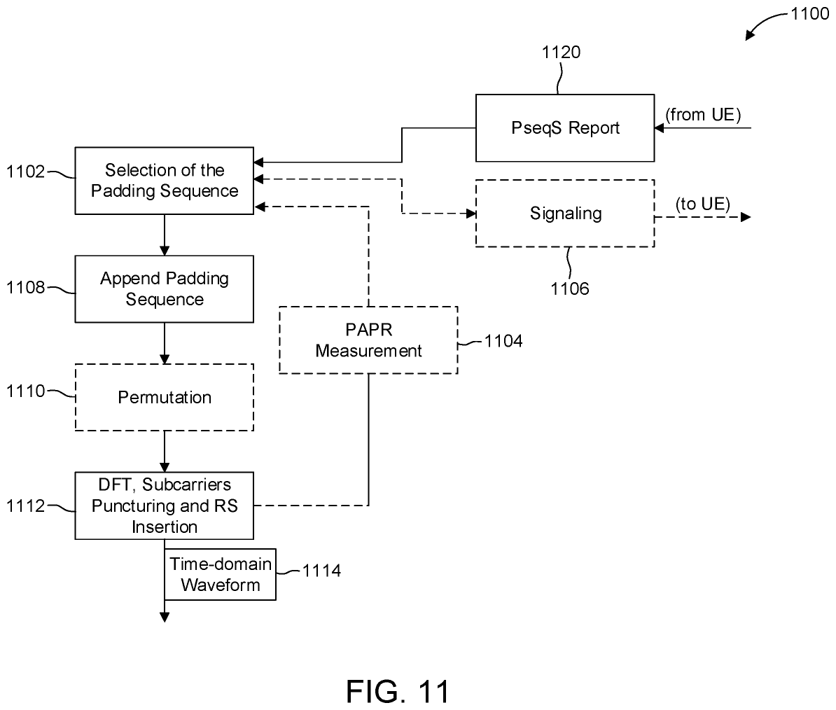

FIG. 11 is a flowchart illustrating an example process 1100 for dynamic RS insertion at the BS side. In the example of FIG. 11, the Base Station (BS) performs the following example steps for dynamic insertion of distributed RS.

In the example of FIG. 11, one or multiple padding sequences are dynamically selected by the BS in step 1102. In some implementations the padding sequences are selected by the BS from among a set of padding sequence structures, e.g., as specified in a pre-determined codebook, e.g., based on PAPR measurements 1104 performed by the BS e.g., based on signaling 1106 with the WTRU. Signaling 1106 may include, for example, time-domain measurements performed by the WTRU (e.g., User Equipment (UE)) over the current symbol and/or several previous symbols, and on feedback reports sent on a periodic, semi-periodic, on-demand or event-based fashion by the WTRU. In some implementations, the padding sequences are selected by the BS from among a set of padding sequence structures based on a PseqS report 1120 from the WTRU. The padding sequences are appended to the modulated data symbols in step 1108.

In some implementations, a permutation is optionally applied, in step 1110, over the resulting block of data and padding symbols, e.g., in such a way that the complex modulated symbols after permutation are uncorrelated and the permuted positions of the padding symbols are different modulo-L from one another.

In some implementations, DFT is performed in step 1112. In some implementations, an M-point DFT is performed, and the subcarriers located at the target pilot positions are punctured and replaced by L RS symbols (which may be either complex-valued, or blank). In some implementations, standard DFT-s-OFDM processing follows to generate the time-domain waveform 1114 and PAPR measurements 1104 are performed by the BS, e.g., to refine the padding sequence selection step 1102 in subsequent time intervals.

In some implementations, the BS optionally signals to the WTRU, in signaling 1106, the padding sequence structure(s) used. In some implementations, the padding sequence structures are signaled based on one or multiple padding sequence structure identifier (PSeqS ID) fields. In some implementations, the PSeqS ID fields may be sent once during session establishment and/or may be dynamically updated during data transfer. In some implementations, the sequence identifier(s) may be blindly detected by the WTRU without the need for explicit signaling.

In some implementations, the BS may send multiple PSeqS ID fields, or a combined PSeqS ID field, to the WTRU in signaling 1106, e.g., including an indication or indications of the padding sequence structure or structures to be used for each TRP (e.g., in cases where multiple transmission/reception points (TRP) may be used to transmit the data channel, e.g., with different or same transport blocks, different or same redundancy versions of the same transport block, or different or same code words, etc., using the fully/partially/non-overlapped time-frequency resources for example using different DL beams.)

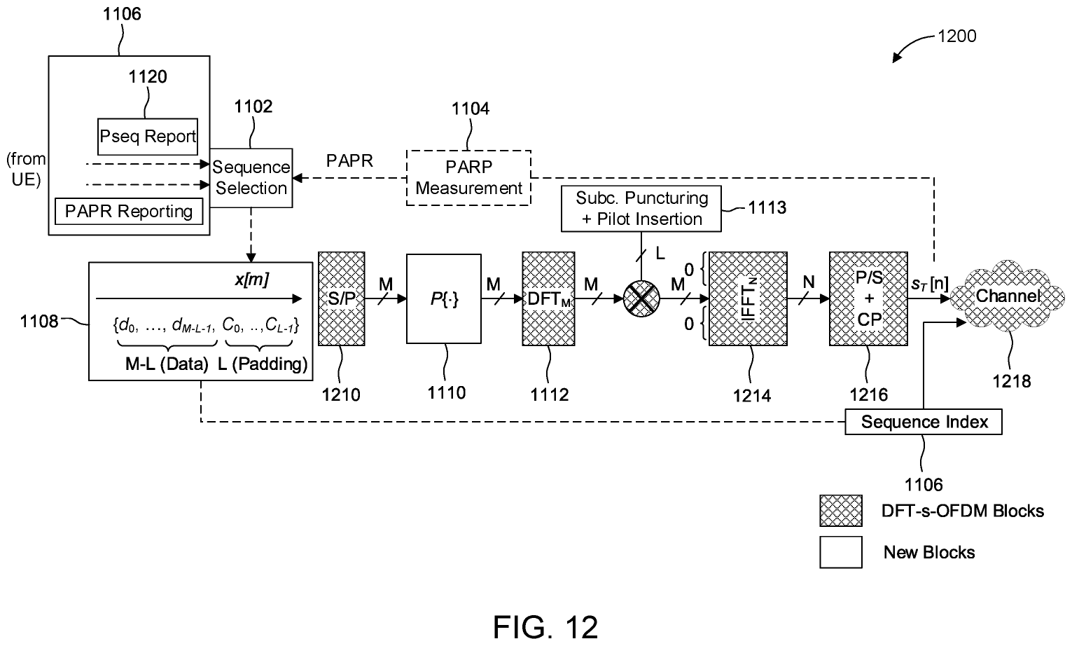

FIG. 12 is a flow chart 1200 illustrating processing at the BS side corresponding to the procedure 1100 shown and described with respect to FIG. 11. Steps in the flowchart of FIG. 11 are detailed in the following description of FIG. 12. Without loss of generality, detailed descriptions herein consider the case of a single padding sequence. FIG. 12 also shows S/P 1210, IFFT 1214, and P/S and CP 1216, as well as channel 1218 over which the time domain waveform 1114 is transmitted.

Regarding selection of the padding sequence in step 1102, in some implementations, the BS receives one, or multiple, feedback reports from the WTRU (e.g., a UE) in signaling 1106. In some implementations, the feedback reports include indications of preferred padding sequences and/or demodulation performance. In some implementations, this, e.g., together with PAPR measurements obtained by the BS, or time-domain measurements performed by the WTRU in the current symbol and/or several previous symbols, may be used to select the type(s) and/or length(s) of the padding sequence(s) that best meet the objectives of the service/application in step 1102. In some implementations, the padding sequences to be used may be indicated in a pre-defined codebook which may be known a-priori by the BS and/or WTRU.

In some implementations, time-domain measurements at the WTRU side may include any metric to measure the deviation of the signal with respect to a pure single-carrier; e.g., the absolute magnitude of the interference caused by RS puncturing and insertion, or time-domain autocorrelation of the signal after interference cancellation. Both may be indicative of how far the signal is from being single-carrier, and may help the BS steer the selection of the padding sequence structure. In some cases the absolute magnitude of the interference caused by RS puncturing and insertion, and time-domain autocorrelation of the signal after interference cancellation may yield a better insight than PAPR measurements at the BS side, e.g., because PAPR may be averaged over a large number of DFT-s-OFDM symbols for precision.

In some implementations, PAPR and time-domain measurements may be performed over the current symbol and/or several previous symbols. The number of symbols for PAPR/time-domain measurements may be indicated by the BS in a time-domain measurement configuration information using e.g., DCI or a semi-periodic/periodic RRC configuration message. In some implementations, if time-domain measurements are performed by the WTRU, measurement reports may be included in a time-domain reporting message sent to the BS via a control or data channel; e.g., over UCI or as part of PUSCH. In some such cases the BS may configure the timing of time-domain reporting messages; e.g., through a time-domain reporting configuration information in DCI or an RRC time-domain reporting configuration message. In some implementations, time-domain measurements by the WTRU may be performed over the time-domain signal that results after equalization and discarding of all the frequency subcarriers that are not allocated for that WTRU; e.g., in order to not be affected by the PAPR of the signals intended for other users.

In some implementations, the WTRU may be configured to provide periodic measurement reports, semi-persistent, or event-based reporting. Alternatively, in some implementations, the WTRU may receive a message from the BS (e.g., in signaling 1106) requesting a time-domain measurement report. In some implementations, the WTRU may determine not to send time-domain reporting messages if measurements are not reliable; e.g., because of excessive noise or channel impairments. In some implementations, an indication not to send time domain reporting messages may be signaled to the BS; e.g., by an RRC time-domain measurement configuration reject, or a null time-domain reporting message.

In some implementations, PAPR and demodulation performance may be traded-off; e.g., depending on the application. For example, applications for which performance is of critical importance can prioritize BER/BLER at the cost of some PAPR degradation, while others intended for use with low-cost devices whose performance is not so critical can prioritize PAPR to maximize the energy efficiency.

In some implementations, the sequence selection step 1102 may be based on one or more of the following guidelines, not precluding other possibilities, depending on the implementation: a set of a-priori known padding sequence structures included in a codebook may be first categorized in terms of their PAPR and performance characteristics; both the sequences and their associated characteristics may be a-priori known by the BS and the WTRU; the BS, after measuring the PAPR of a given DFT-s-OFDM symbol or set of symbols in one or several previous time intervals, may determine to change the padding sequence to another one with lower PAPR according to a target PAPR semi-statically or dynamically set by an application, or configured by higher layers; the BS may determine to switch to another padding sequence characterized by better performance if the metrics contained in the feedback report show poorer performance than a target set by an application, or configured by higher layers; and/or the BS may also consider an explicit indication from the WTRU to switch to a preferred padding sequence during the sequence selection process.

In some implementations, in addition to being based on PAPR and performance, sequence selection step 1102 may be semi-statically or dynamically based on instantaneous network/cell conditions. For example, in some implementations, PAPR in a multi-user scenario based on DFT-s-OFDM may be dependent on the number of active users; e.g., where each user includes a cluster of contiguous subcarriers. In some implementations, cell load may steer sequence selection towards optimizing PAPR or performance in a dynamic way; e.g., depending on the power budget at the BS side. In some implementations, sequence selection may also involve Machine-Learning (ML) algorithms trained to suggest a padding sequence based on one or several PAPR measurements, the network/cell load, and/or the WTRU's feedback reports. In some implementations, the sequence selection process may be aimed towards optimizing PAPR, or performance, based on cell load, e.g., depending on the power budget at the BS side (e.g. a high cell load may trigger a sequence selection based on PAPR optimization if the BS power is constrained).

In some implementations, the timescale of the padding sequence selection step 1102 may range from very long (connection-based) to very fast (symbol-based) and adaptive. In some implementations, different timescales are used depending on the application and may be influenced by the periodicity of the feedback reports sent by the WTRU. For example, in some implementations, very long means e.g., on the order of minutes, or hours, e.g., as determined by the duration of the connected session. In some implementations, very fast means e.g., on the order of microseconds, e.g., as determined by the duration of the symbols In some implementations, the periodicity of PSeqS ID indications, if present, may be equal to the timescale of sequence selection (e.g., to provide signaling indications with the same periodicity as the sequence selection process); e.g., in such a way that signaling procedures that are updated over long time periods correspond to long timescales (e.g., on the order of minutes, or hours, e.g., as determined by the session duration) in the sequence selection process and vice versa.

In some implementations, in cases where multiple transmission/reception points (TRP) may establish a wireless connection to the WTRU, the BS may send (e.g., in signaling 1106) multiple PSeqS ID fields, or a combined PSeqS ID field, to the WTRU; e.g., including indications of the padding sequence structure or structures used for each TRP; e.g., through a single DCI, multiple DCIs (e.g., associated with different TRP transmissions), and/or as part of Radio Resource Control (RRC) setup, and/or dynamically updated during data transfer within the DCI.

In some implementations, a received uplink PSeqS report 1120 may include, without limitation, any or several of the following indications from the WTRU side: a preferred padding sequence structure identifier (PSeqS ID); the mean squared error (MSE) of the interference estimation during the signal detection process; the post-detection signal-to-noise ratio (SNR); high-level (e.g., from a protocol layer above the physical layer, e.g. the MAC or RLC layers) performance metrics (e.g., such as bit error rate (BER) or block error rate (BLER), before or after Forward Error Correction (FEC)); and/or metrics related to convergence of a Successive Interference Cancellation (SIC) algorithm (e.g., the number of iterations or the residual error).

In some implementations, e.g., when more than one TRP have established a connection with the WTRU, multiple PSeqS reports 1120 may be independently sent by the WTRU to multiple TRPs. In some implementations, each such report may include any or several of the above indications to any of the TRPs involved. In some implementations, a single (e.g., joint) report including the PSeqS reports 1120 for one or more TRP transmissions may be sent.

In some implementations, PSeqS reports 1120 may be sent by the WTRU on a periodic, semi-periodic, on-demand and/or event-based fashion. In some implementations, when the PSeqS reports are sent periodically, their periodicity may follow the rate of variation of the wireless channel and/or the variations in WTRU performance (e.g., the periodicity should be enough to respond to the variations in the channel and/or WTRU performance).

In some implementations, padding sequences may have a length different than L. In some such cases, the number of data symbols is different from (M-L) to match the DFT size of the transform precoding stage, M (e.g., the sum of the padding sequence length and the number of data symbols shall be equal to the DFT size). In some implementations, padding lengths higher than L may lead to less than (M-L) available data symbols (which may be compensated by adjusting the available parity bits after the FEC encoding stage), but also better estimation of the interference from RS insertion. In some implementations, padding lengths lower than L may lead to higher spectral efficiency but poorer interference estimation at the receiver. In some implementations, the BS may thus alternate between larger or smaller padding sequences without changing the sequence type. In some implementations, the various techniques herein are also valid for the case of using padding lengths different from L.

Without loss of generality, this and other solutions consider padding sequences of length L to simplify descriptions.

Regarding appending one or more padding sequences to the data block in step 1108, in some implementations, one, or several, padding sequences c[m]={c[0], . . . , c[L−1]} may be appended at the end of the data block d[m]={d[0], . . . , d[M−L−1]} that is input to the DFT stage, in such a way that the combined block x={d[0], . . . , d[M−L−1], c[0], . . . , c[L−1]} has length M. In some implementations, the use of one padding sequence allows RS insertion with a regularly spaced pattern

$$\{ k \frac{M}{L} + p , k = 0 , ... , L - 1 \} ,$$

where p can be any integer of the set

$$p ∈ \{ 0 , ... , \frac{M}{L} - 1 \} .$$

In some implementations, the use of two concatenated padding sequences, c₁ and c₂, may enable RS patterns of the form

$$\{ {k}_{1} \frac{M}{L} + {p}_{1} , {k}_{1} = 0 , ... , L - 1 \} , \{ {k}_{2} \frac{M}{L} + {p}_{2} , {k}_{2} = 0 , ... , L - 1 \}$$

with two a-priori know frequency shifts

$${p}_{1} , {p}_{2} ∈ \{ 0 , ... , \frac{M}{L} - 1 \}$$

w yiciu a complex block of the form x={d[0], . . . , d[M−L−1], c₁[0], . . . , c₁[L−1], c₂[0], . . . , c₂[L−1]}.

Denoting the symbol positions of the padding sequence as {iₖ=M−L+k, k=0, . . . , L−1}, some examples of padding sequences include constant-envelope sequences, sequences with sign-reversed data symbols, sequences with phase-shifted data symbols, and/or blank fields, for example.

Constant-envelope sequences may include any sequence with constant amplitude like Zadoff-Chu, m-sequence, or any similar one may fit this type. In some implementations, these sequences may minimize PAPR but do not add any extra information to the modulated data symbols, hence leaving less energy to data and introducing some performance degradation as a result.

Sequences with sign-reversed data symbols may include where the padding sequence is, equal to L selected modulated data symbols with the sign reversed (other possibilities can also be defined) as in the following equation:

$$c [ {i}_{k} ] = - d [ ( {i}_{k} + L ) mod M ]$$

In some implementations, this sequence with sign-reversed data symbols allows some noise reduction upon reception by accumulating its complex values with the corresponding data symbols during the interference estimation process. However, the high autocorrelation introduced in the time domain may reinforce the spectral components of the pilot positions after DFT. In some implementations, puncturing introduces an additive interference equal to minus the value of the spectral components at the pilot positions, thus leading to higher degradation. In some implementations, this undesirable autocorrelation may be minimized by the permutation step 1110 which randomizes the padding symbol positions. In some implementations, another way to minimize autocorrelation is to avoid the sign-reversal of a block of consecutive data symbols by picking data symbols in groups of L samples, e.g. as in the following equation:

$$c [ {i}_{k} ] = - d [ ( {i}_{k} + kL ) mod ( M - L ) ]$$

Other possibilities can also appear depending on implementations.

Sequence with phase-shifted data symbols may include, for example, where the padding sequence involves a phase-shifted replica of L selected data symbols as in the following equation:

$$c [ {i}_{k} ] = {e}^{j θ} d [ ( {i}_{k} + kL ) mod ( M - L ) ]$$

Here, θ is an a-priori known phase that can be adjusted to meet different objectives. The sign-reversed case would be a particular case with θ=π. In some implementations, phase shifts close to π/2 may yield better PAPR and slightly higher bit signal-to-noise ratio (Eb/NO) than the sign-reversed case, and in some implementations, phase shifts close to zero may increase autocorrelation while also enhancing noise during the interference estimation process at the receiver. Many other possibilities exist by selecting different values of θ.

Blank field may include, for example, where the padding sequence is simply a set of blank symbols, as in the following equation:

c[iₖ]=0

This case is described above regarding RS insertion by subcarrier puncturing, which in some implementations facilitates interference estimation by allowing an energy boost in the non-null data symbols to keep the power unchanged, but in some implementations also introduces a higher PAPR than the constant-envelope sequence.

The above-described sequences are examples showing the trade-offs between performance, PAPR and detection complexity. In some implementations, e.g., depending on implementation, a codebook of padding sequences may be used that are different than those described. without departure from the present disclosure.

Regarding permutation step 1110, in some implementations, a permutation may be applied to randomize the resulting block {x[iₖ], iₖ=0, . . . , M−1} and avoid undesired high residual autocorrelation before the DFT stage, to yield the block of complex symbols (keeping for simplicity the single-sequence case) as in the following equation:

$$\{ {d}^{′} [ 0 ] , ... , {d}^{′} [ M - 1 ] \} = \{ x [ \{ {i}_{k} \} ] , {i}_{k} = 0 , ... , M - 1 \}$$

where [symbol] {·} denotes any permutation satisfying the following properties:

$$∀ {i}_{k} \neq {i}_{j} : {i}_{k} , {i}_{j} ∈ \{ 0 , ... , M - 1 \} ⇒ E \{ x [ \{ {i}_{k} \} ] {x}^{*} [ \{ {i}_{j} \} ] \} = 0$$

$$∀ {i}_{k} \neq {i}_{j} : {i}_{k} , \\ {i}_{j} ∈ \{ M - L , M - L + 1 , ... , M - 1 \} ⇒ ( \{ {i}_{k} \} - \{ {i}_{j} \} ) mod L \neq 0$$

That is, in some implementations, the complex modulated symbols after permutation step 1110 are uncorrelated, and the permuted positions of the symbols of the padding sequence are different modulo-L from one another. Here, iₖ and iⱼ represent indices of the complex symbols before permutation, and mod L denotes the modulo-L operation, i.e., the remainder after division by L. In some implementations, uncorrelation of the complex symbols may be achieved by positioning the complex symbols after permutation differently for different time instants, e.g., when padding sequences are data-dependent (e.g., as in the sign-reversed of phase-shifted cases described above). In some implementations, given that the interference from subcarrier puncturing is periodic in time, with period L, the padding symbols may be used by the receiver to estimate such interference if (e.g., only if) the positions after permutation are different modulo-L.

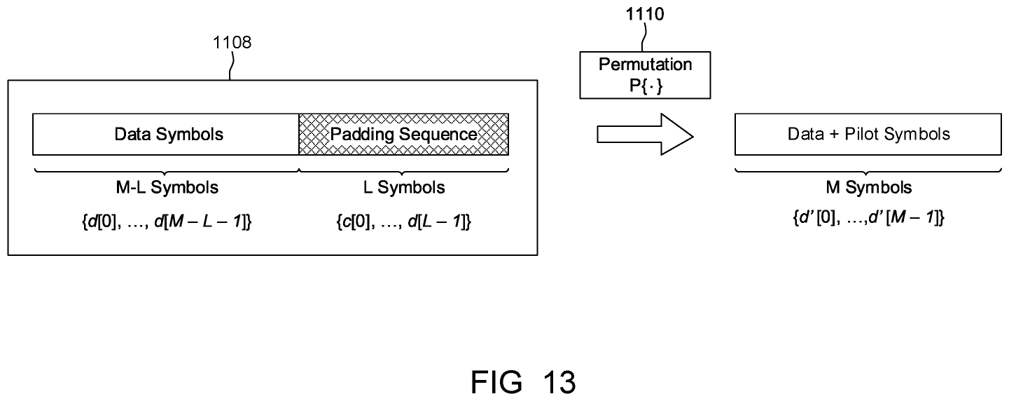

FIG. 13 is a diagram illustrating the sequence padding step 1108 and permutation step 1110 discussed with respect to FIG. 11 and FIG. 12.

After subcarrier puncturing and RS insertion, in some implementations, an M-point DFT may be performed over the permuted block {d′ [0], . . . , d′ [M-1]}. In some implementations, after the M-point DFT is performed, the subcarriers located at the intended pilot positions may punctured, and a-priori known RS symbols may be inserted in the frequency domain.

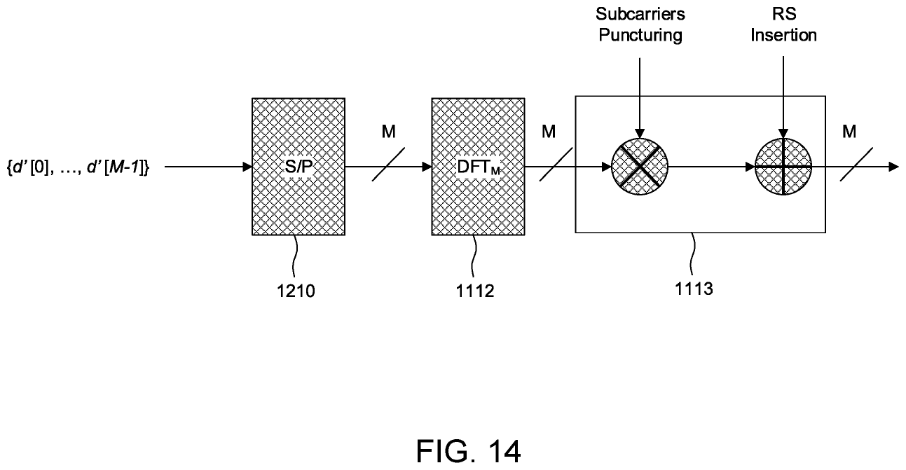

FIG. 14 is a diagram illustrating detail of the S/P step 1210, DFT step 1112, subcarrier puncturing and RS insertion step 1113 as shown an described with respect to FIG. 11, FIG. 12, and FIG. 13. In some implementations, the inserted RS may include complex a-priori known symbols or blank symbols, e.g., depending on the application. In some implementations, blank symbols may be useful to reserve resource elements in 5G NR intended e.g. for other MIMO layers or antenna ports, or for channel acquisition from other cells.

In some implementations, DFT-s-OFDM processing continues after subcarrier puncturing and RS insertion step 1113 to generate the DFT-s-OFDM time-domain waveform ST[n], including mapping to selected subcarriers in the frequency domain, inverse DFT of size N (IFFT step 1214) parallel-to-serial conversion, and addition of the cyclic prefix (P/S+CP step 1216).

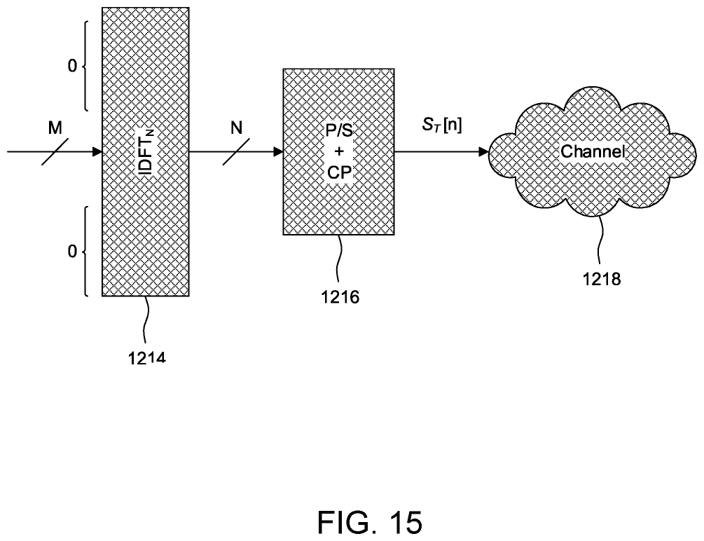

FIG. 15 is a flow chart illustrating detail of further steps for generation of DFT-s-OFDM time-domain waveform, including IFFT step 1214, and P/S+CP step 1216 as shown an described with respect to FIG. 11, FIG. 12, FIG. 13, and FIG. 14. It is noted that further processing steps may be included depending on the implementation.

Regarding PAPR and time-domain measurements, in some implementations, the BS may measure the PAPR of the time-domain signal, and this value may be used together with statistics of PAPR that may have been obtained in current or previous time instants as eventual inputs for selection of the padding sequence, e.g., as shown and described with respect to FIG. 5. In some implementations, time-domain measurements performed at the WTRU may be reported to the BS, e.g., via a time-domain reporting message. In some implementations, configuration of the number of symbols for time-domain measurements and timing of the reporting messages may be provided by the BS, e.g., in a time-domain measurement configuration information and/or a time-domain reporting configuration information, respectively.

In some implementations, time-domain measurements may be performed at the WTRU on the time-domain received signal after equalization, either prior to interference cancellation caused by subcarrier puncturing and RS insertion, or after it. In some implementations, the WTRU may determine not to send time-domain reporting messages, e.g., if measurements are not reliable because of, e.g., excessive noise or channel impairments. In some implementations, this may be signaled to the BS, e.g., by an RRC time-domain measurement configuration reject, or a null time-domain reporting message.

Regarding BS to WTRU and WTRU to BS signaling, in some implementations, the BS optionally sends control information to the WTRU about the padding sequence structure or structures used, e.g., with a periodicity given by the timescale of the sequence selection process. In some implementations, a padding sequence structure identifier (PSeqS ID) field may be sent once during session establishment (e.g. a default one) as part of e.g. Radio Resource Control (RRC) setup, and/or dynamically updated during data transfer within the Downlink Control Information (DCI). Alternatively, in some implementations, a set of supported padding sequence structures with their identifiers may be provided to the WTRU using higher layer signaling (e.g., RRC) e.g., along with an initial active/selected sequence, which may be dynamically switched to another sequence for which the network may use the MAC CE or/and DCI messages to indicate the selected sequence to the WTRU. In some implementations, the WTRU may also perform blind detection of the padding sequence used without the need for explicit signaling.

In some implementations, the periodicity of PSeqS ID indications may be equal to the timescale of the padding sequence selection process, e.g., in such a way that longer timescales (e.g., on the order of minutes, or hours, e.g., as determined by the session duration) correspond with signaling procedures that are updated over longer time periods and vice versa. PSeqS ID information can be sent over different means. By way of example, in some implementations, RRC-based signaling may be employed when sequence selection runs over very long timescales, whereas e.g., DCI-based signaling may be used when sequences are updated on a per-slot basis. In some implementations, other signaling mechanisms with different periodicities are also possible, e.g., using MAC CE signaling. In some implementations, blind detection, if used at the WTRU side, does not require any signaling of PSeqS ID from the BS.

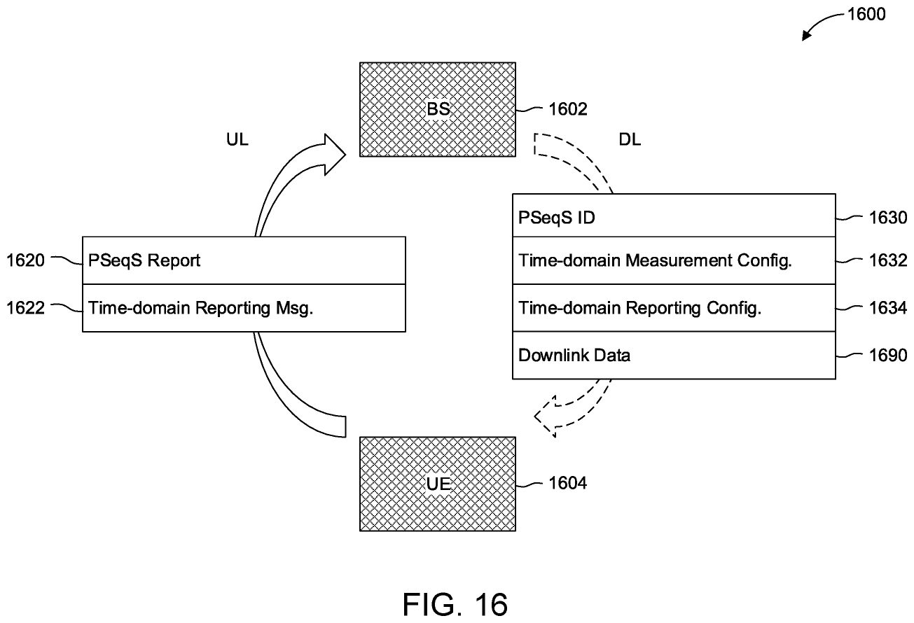

FIG. 16 is a chart which illustrates a feedback loop 1600 between BS 1602 and WTRU 1604 (shown as a UE in FIG. 16), including downlink data 1690, e.g., for dynamic RS insertion at the BS side. In some implementations, the feedback loop 1600 illustrates steps corresponding to steps shown and described with respect to FIG. 11.

In feedback loop 1600, a PSeqS report 1620 is sent by the WTRU (e.g., UE) to the BS 1602, e.g., in a periodic, semi-periodic, on-demand or event-based fashion, e.g., to aid the BS in the sequence selection process.

In some implementations, an optional PSeqS ID 1630 may also be periodically sent to the WTRU, and may include information about the padding sequence used. In some implementations, the BS may also send multiple PSeqS ID fields, or a combined PSeqS ID field, to the WTRU, which may include indications about the padding sequence structure or structures to be used for each TRP. In some implementations, e.g., when no PSeqS ID fields are sent by the BS or said multiple TRPs, the WTRU may perform blind detection of the padding sequence structure or structures. In some implementations, multiple PSeqS reports 1620 may also be sent by the WTRU towards different TRPs in cases where multiple TRPs have established a connection with the WTRU. Alternatively, in some implementations, the WTRU may be configured to send a single (e.g., joint) report containing the PSeqS reports 1620 for one or more TRPs. In some implementations, PSeqS reports 1620 may be sent to the BS e.g., via Medium Access Control Control Elements (MAC CE), but other ways of sending PSeqS reports 1620 are possible in some implementations.

In some implementations, the BS may send additional signaling information (e.g., in a time-domain measurement configuration message 1632) about the number of symbols for time-domain measurements, such as, e.g., a time-domain measurement configuration information (e.g., using DCI), or a semi-periodic/periodic RRC configuration message. In some implementations, this may enable time-domain measurements to be performed at the WTRU 1604 side, if required. In some such cases, the WTRU 1604 may send time-domain measurements to the BS, e.g., by means of suitable time-domain reporting messages 1622, and the BS may send additional timing information (e.g., in time-domain reporting configuration messages 1634), e.g., through a time-domain reporting configuration information in DCI, or an RRC time-domain reporting configuration message.

In some implementations, time-domain reporting messages 1622 may be sent by the WTRU via a control or data channel, e.g., over UCI or as part of PUSCH, to the BS or to multiple TRPs in case of multi-TRP operation. In some implementations, the WTRU may be configured with periodic time-domain reporting messages or padding sequence structure reports, for example, using higher layer signaling, e.g., RRC signaling. Alternatively, in some implementations, the WTRU may be configured with semi-persistent reporting using RRC signaling, where a set of reports may be configured and a DL MAC CE or DCI to activate/deactivate one of configured set. In some implementations, for periodic/semi-persistent reporting, the WTRU may be configured with uplink resources (e.g., over the PUCCH) to send the reports. Alternatively, in some implementations, the WTRU may receive MAC CE or DCI message (e.g., dynamically) requesting the time-domain measurement report. In some implementations, the WTRU may send the time-domain reporting messages or padding sequence structure reports with the next available PUCCH resource or using configured uplink resources on the uplink shared channel (e.g., PUSCH). In cases where the WTRU does not have any configured uplink resources, in some implementations, the WTRU may send a scheduling request to request to allocate uplink resources on the uplink shared channel to send reports. In some implementations, a new MAC CE or/and DCI may be configured for this purpose. In some implementations, a new WTRU identity (e.g., X-RNTI) may be configured to the WTRUs on a unique or group basis, e.g., to decode the DCIs containing the reporting configuration. In another example, the WTRU may be configured with event-based reporting. In some implementations, the WTRU may be configured with a threshold or thresholds, number of receptions, or duration (e.g., time-to-trigger) to be used to make the measurements included in the reports. In some implementations, the WTRU may be configured to send a report when an event is triggered; e.g., when a measurement (e.g., MSE, SNR, BER, etc.), or average of the configured number of measurements, or average of the number of measurements made over the configured duration meets a configured threshold (e.g., is below, above, or equal to a configured threshold, as desired). In some implementations, the event-triggered or event-based report may be sent via a UL MAC CE, UL RRC, or UCI message.

Some implementations relate to semi-static insertion of distributed RS at the BS side without WTRU feedback.

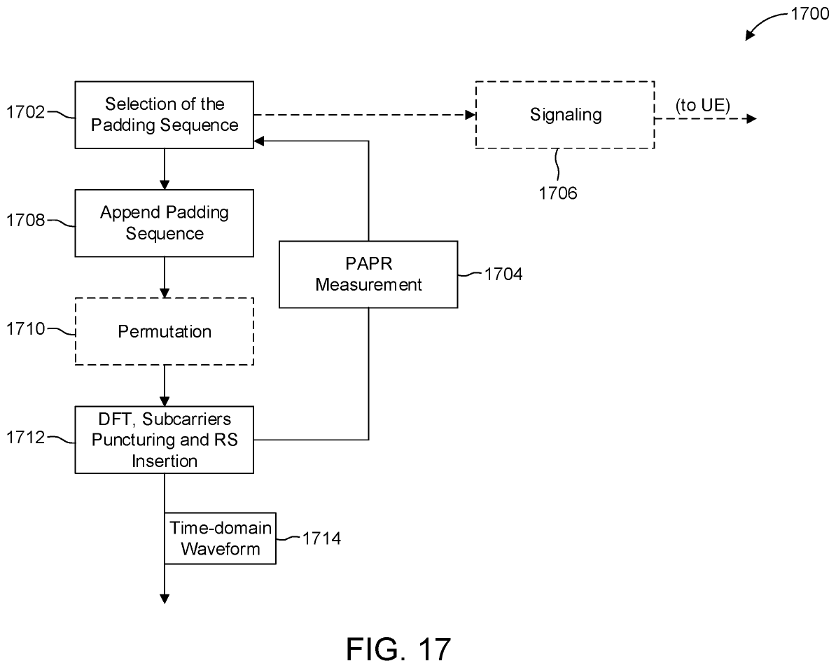

FIG. 17 is a flow chart illustrating an example process 1700 for semi-static RS insertion at the BS side. In the example of FIG. 17, the BS performs the following example steps for semi-static insertion of distributed RS.

In some implementations, one or more padding sequences may be selected (e.g., semi-statically selected) by the BS in step 1102. In some implementations, the padding sequences are selected by the BS from among a set of padding sequence structures specified in a pre-determined codebook, e.g., based on pre-defined policies and/or PAPR measurements 1704 performed by the BS over the current symbol and/or several previous symbols. The one or more padding sequences may be appended to the modulated data symbols in step 1708.

In some implementations, a permutation is optionally applied, in step 1710, over the resulting block of data and padding symbols, e.g., in such a way that the complex modulated symbols after permutation are uncorrelated and the permuted positions of the padding symbols are different modulo-L from one another.

In some implementations, an M-point DFT is performed in step 1712. In some implementations, the subcarriers located at the target pilot positions are punctured and replaced by L RS symbols (which may be either complex-valued, or blank). In some implementations, standard DFT-s-OFDM processing follows to generate the time-domain waveform 1714 and PAPR measurements 1704 are performed by the BS, e.g., to refine the padding sequence selection step 1702 in subsequent time intervals.

In some implementations, the BS optionally signals to the WTRU (e.g., in signaling 1706) an indication of the padding sequence structure or structures used, e.g., using one or more padding sequence structure identifier (PSeqS ID) fields, that may be sent once during session establishment and/or dynamically updated during data transfer, or alternatively the sequence structure identifier or identifiers may be known a-priori by both transmitter and receiver or may be blindly detected by the receiver without the need for explicit signaling. In cases where multiple transmission/reception points (TRP) may establish a wireless connection to the WTRU, in some implementations, the BS may send multiple PSeqS ID fields, or a combined PSeqS ID field, to the WTRU, e.g., including indications about the padding sequence structure or structures to be used for each TRP.

It is noted that process 1700 illustrates an example procedure at the BS side, which is similar to the procedure shown and described with respect to FIG. 11, except for the absence of a PSeqS report from the WTRU, and the unidirectionality of the signaling information from BS to WTRU.

In some implementations, selection of the padding sequence in step 1702 is based on higher-layer signaling, PAPR measurements performed by the BS over the current symbol and/or several previous symbols, semi-static policies, and/or any other suitable strategy that does not require feedback from the WTRU side. Alternatively, in some implementations, both the BS and WTRU may have a-priori knowledge of the padding sequence structure or structures used without the need for explicit indication. In some implementations, the padding sequence structures to use may be included in a pre-defined codebook, e.g., known a-priori by the BS and WTRU.

In process 1700, one or multiple padding sequences may be semi-statically selected by the BS among a set of padding sequence structures specified in a pre-determined codebook, based on PAPR measurements performed by the BS over the current symbol and/or several previous symbols, and are appended in step 1708 to the modulated data symbols prior to the DFT stage.

In some implementations, a permutation is optionally applied in permutation step 1710 over the resulting block of data and padding symbols in such a way that the complex modulated symbols after permutation are uncorrelated and the permuted positions of the padding symbols are different modulo-L from one another.

In some implementations, an M-point DFT is performed, and the subcarriers located at the target pilot positions are punctured and replaced by L RS symbols (which may be either complex-valued, or blank) in step 1712

In some implementations, standard DFT-s-OFDM processing follows to generate the time-domain waveform 1714 and PAPR measurements 1704 are taken to refine the padding sequence selection in subsequent time intervals.

In some implementations, the BS optionally signals to the WTRU (e.g., in signaling 1706) an indication of the padding sequence structure or structures used by means of one or multiple padding sequence structure identifier (PSeqS ID) fields, that may be sent once during session establishment and/or dynamically updated during data transfer, or alternatively the sequence identifier or identifiers may be blindly detected by the WTRU without the need for explicit signaling. In some implementations, e.g., where multiple transmission/reception points (TRP) may be used to transmit the data channel, e.g., with different or same transport blocks, different or same redundancy versions of the same transport block, or different or same code words, etc., using the fully/partially/non-overlapped time-frequency resources for example using different DL beams, the BS may send (e.g., in signaling 1706) multiple PSeqS ID fields, or a combined PSeqS ID field, to the WTRU, including indications of the padding sequence structure or structures to be used for each TRP.

In some implementations, in the optional signaling 1706 shown with dashed lines, the BS may send to the WTRU the padding sequence structure used, e.g., using a padding sequence structure identifier (PSeqS ID) field. In some implementations, a PSeqS ID may be sent once during session establishment (e.g., a default PSeqS ID), e.g., as part of RRC setup, and/or dynamically updated during data transfer within the DCI. Alternatively, in some implementations, a set of supported padding sequences with their identifiers may be provided to the WTRU using higher layer signaling (e.g., RRC) in some implementations along with an initial active/selected sequence, which in some implementations, may be dynamically switched to another sequence for which the network may use the MAC CE or/and DCI messages to indicate the selected sequence to the WTRU. In some implementations, in another alternative, the padding sequence may be known a-priori by both BS and WTRU, or the WTRU may perform blind detection of the padding sequence used without the need for explicit signaling.

In some implementations, the BS may also send multiple PSeqS ID fields, or a combined PseqS ID field, to the WTRU, including indications of the padding sequence structure(s) to be used for each TRP in cases where multiple TRPs have established a connection with the WTRU.

In some implementations, the periodicity of PSeqS ID indications may be equal to the timescale of the padding sequence selection process, e.g., in such a way that longer timescales correspond with signaling procedures that are updated over longer time periods and vice versa. In some implementations, PSeqS ID information may be sent in different ways. For example, in some implementations, PSeqS ID information may be sent by RRC-based signaling, e.g., in cases where sequence selection runs over very long timescales (e.g., on the order of minutes, or hours, e.g., as determined by the session duration), whereas DCI-based signaling may be used in cases where sequences are updated on a per-slot basis. In some implementations, other signaling mechanisms with different periodicities are also possible. In some implementations, blind detection, if used at the WTRU side, does not require any signaling of PSeqS ID from the BS.

Some implementations relate to data detection and interference cancellation at the WTRU side.

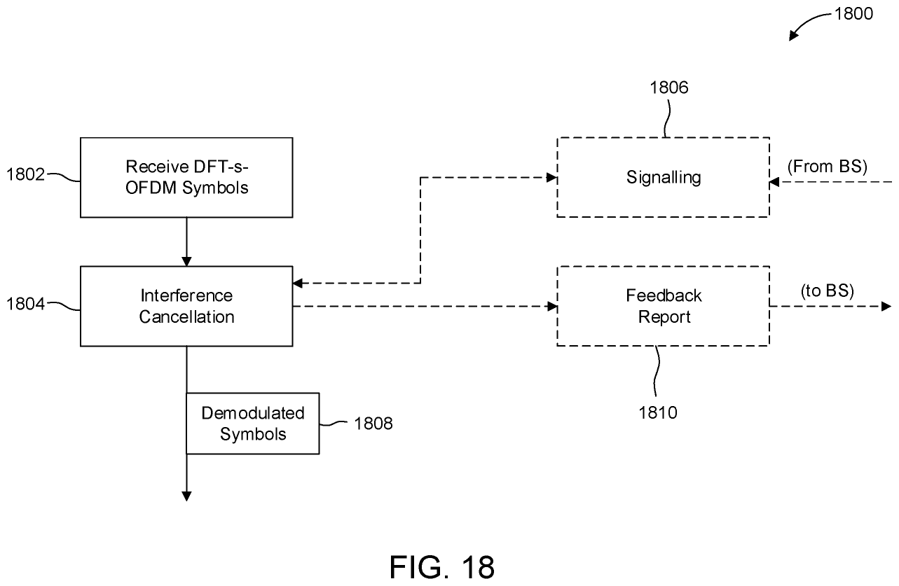

FIG. 18 is a flow chart illustrating example procedure 1800 for data detection and cancellation of interference from RS insertion at the WTRU side. In the example of FIG. 18, the WTRU performs the following example steps for interference cancellation and recovery of the data.

In some implementations, the WTRU may obtain periodic signaling information 1806 from the BS. In some implementations, signaling information 1806 includes an indication of the padding sequence structure or structures used among the sequence structures included in a pre-determined codebook, or alternatively the WTRU may have information regarding the sequence structure or structures in advance, or may perform blind detection of the padding sequence structure or structures without the need for explicit signaling.

In some implementations, DFT-s-OFDM symbols are received in step 1802. In some implementations, the DFT-s-OFDM symbols include complex modulated data symbols affected by interference caused by subcarrier puncturing.

In some implementations, interference is cancelled in step 1804 and the complex modulated symbols 1808 are estimated and delivered to the higher layers.

In some implementations, a feedback report 1810 is optionally sent to the BS. In some implementations, feedback report 1810 includes PSeqS reports, e.g., in a periodic, semi-periodic or on-demand fashion, e.g., to aid in the padding sequence selection process. In some implementations, feedback report 1810 includes time-domain reporting messages indicating time-domain measurements performed by the WTRU.

In the example procedure 1800, both the signaling from the BS and the feedback reports towards the BS are optional and depicted with dashed lines.

Here, similar to the signaling blocks shown and described with respect to FIGS. 11-17, one or multiple padding sequence structure identifier (PSeqS ID) fields may be either periodically received from the BS via control signaling or a-priori known at both BS and WTRU sides, e.g., based on pre-defined policies. Alternatively, in some implementations, a set of supported padding sequence structures with their identifiers may be provided to the WTRU, e.g., using higher layer signaling (e.g., RRC) e.g., along with an initial active/selected sequence, which may be dynamically switched to another sequence for which the network may use the MAC CE or/and DCI messages to indicate the selected sequence to the WTRU. In some implementations, the one or more padding sequence structures can also be inferred by the WTRU via blind detection. In some implementations, the sequence structures may be elements of a pre-defined codebook e.g., known a-priori by the BS and WTRU, e.g., to simplify detection.

In some implementations, the periodicity of PSeqS ID indications may be equal to the timescale of the padding sequence selection process, e.g., in such a way that longer timescales (e.g., on the order of minutes or hours, e.g., as determined by the session duration) correspond with signaling procedures that are updated over longer time periods (e.g., on the order of minutes or hours, e.g., as determined by the session duration) and vice versa. In some implementations, PSeqS ID information may be sent in other ways. For example, in some implementations, RRC-based signaling may be employed, e.g., when sequence selection runs over very long timescales (e.g., on the order of minutes or hours, e.g., as determined by the session duration), whereas e.g., DCI-based signaling may be used, e.g., when sequences are updated on a per-slot basis. In some implementations, other signaling mechanisms with different periodicities are also possible.

In cases where multiple transmission/reception points (TRP) may establish a wireless connection to the WTRU, the WTRU may receive multiple PSeqS ID fields, or a combined PSeqS ID field, from the BS, including indications about the padding sequence structure(s) used by each TRP, e.g., through a single DCI or as part of Radio Resource Control (RRC) setup, and/or dynamically updated during data transfer within the DCI.

In some implementations, e.g., as in the signaling procedures shown and described with respect to FIG. 11, further signaling may be exchanged between BS and WTRU, which may include information about the number of symbols for time-domain measurements in a time-domain measurement configuration information using DCI, or a semi-periodic or periodic RRC configuration message. Timing information of time-domain measurements can also be sent by the BS through e.g. a time-domain reporting configuration information in DCI, or an RRC time-domain reporting configuration message.

In some implementations, the WTRU may be configured with periodic time-domain reporting messages or padding sequence structure reports, for example, using higher layer signaling, e.g., RRC signaling. Alternatively, in some implementations, the WTRU may be configured with semi-persistent reporting using RRC signaling, e.g., where a set of reports may be configured and a DL MAC CE or DCI may be used to activate/deactivate one of configured set. In some implementations, e.g., for periodic and/or semi-persistent reporting, the WTRU may be configured with uplink resources (e.g., over the PUCCH) to send the reports. Alternatively, in some implementations, the WTRU may receive an on-demand MAC CE or DCI message (e.g., dynamically) requesting the report. In some implementations, the WTRU may send the time-domain reporting messages and/or padding sequence structure reports with the next available PUCCH resource or may send using configured uplink resources on the uplink shared channel (e.g., PUSCH). In some implementations, e.g., in cases where the WTRU does not have any configured uplink resources, the WTRU may send a scheduling request to request to allocate uplink resources on the uplink shared channel to send reports. In some implementations, a new MAC CE and/or DCI may be configured for this purpose. In some implementations, a new WTRU identity (e.g., X-RNTI) may be configured to the WTRUs, e.g., on a unique or group basis, e.g., to decode the DCIs that include the reporting configuration. In another example, In some implementations, the WTRU may be configured with event-based reporting. In some implementations, he WTRU may be configured with threshold(s), a number of receptions, or a duration (e.g., time-to-trigger) to be used to make the measurements included in the reports. In some implementations, he WTRU may be configured to send a report when an event is triggered, e.g., when a measurement (e.g., MSE, SNR, BER, etc.) or average of the configured number of measurements or average of the number of measurements made over the configured duration is below/above a configured threshold. In some implementations, the event-triggered or event-based report may be sent via a UL MAC CE, UL RRC, or UCI message.

Regarding the receive DFT-s-OFDM symbols step 1802 shown and described with respect to FIG. 18, in some implementations, DFT-s-OFDM processing takes the time-domain received waveform SR[n] and delivers data symbols affected by interference from subcarrier puncturing.

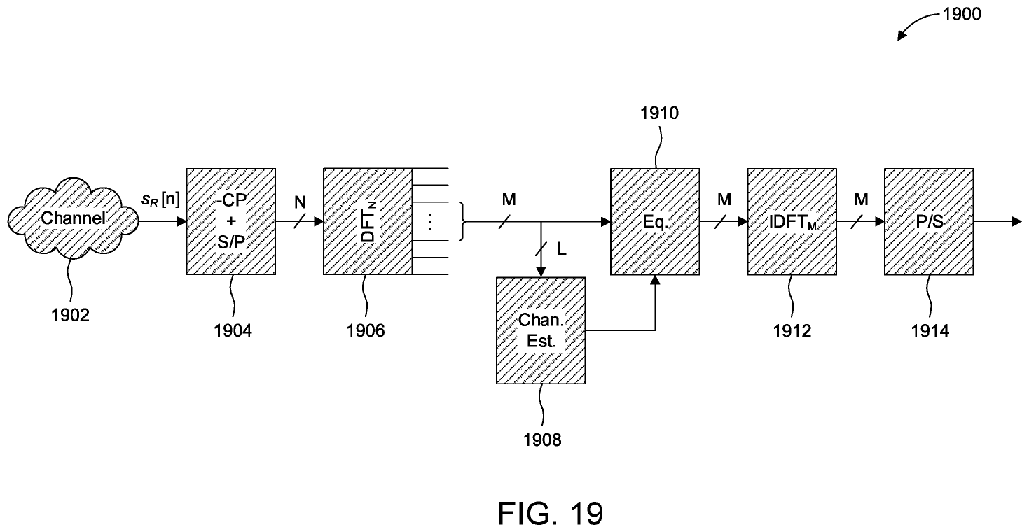

FIG. 19 is a block diagram of a procedure 1900 which illustrates further detail of an example of the receive DFT-s-OFDM symbols step 1802 (shown and described with respect to FIG. 18). Procedure 1900 includes receiving time-domain received waveform S_{R}[n] from channel 1902, CP removal (−CP) and serial/parallel conversion (S/P) in step 1904, N-point DFT (DFT_{N}) in step 1906, extraction of the M subcarriers allocated to the user (shown in the bracket following step 1906), channel estimation in step 1908, equalization (Eq.) in step 1910, M-point inverse DFT (IDFTM) in step 1912, and) parallel/serial conversion (P/S) in step 1914. In some implementations, further or different processing blocks may be possible.

Regarding the interference cancellation step 1804 (as shown and described with respect to FIG. 18) in some implementations, interference cancellation includes cancellation of the interference introduced in the subcarrier puncturing process at the BS side. In some implementations, the WTRU may exploit the presence of the padding sequence, e.g., to help estimate and/or further remove the interference term from the time-domain symbols prior to demodulation. In some implementations, any suitable detection strategy can serve, including successive interference cancellation (SIC), maximum-likelihood (ML) detector, or others.

To illustrate this point, subcarrier puncturing and RS insertion following a pattern

$$\{ k \frac{M}{L} + p , k = 0 , ... , L - 1 \}$$

yields an interference term that contains an L-periodical term p[m] in the time domain, frequency-shifted by p in the following expression:

$$p [ m ] {e}^{\frac{j 2 π pm}{M}}$$

Here, m is an index of the samples in the time domain. In some implementations, the DFT of p[m] is equal to the RS symbols inserted minus the values of the punctured subcarriers. In some implementations, the receiver may thus exploit this term to estimate the interference with the aid of the padding symbols c[m] appended to the data after properly undoing the permutation step and the frequency shift p.

Regarding feedback report 1810 (as shown and described with respect to FIG. 18) in some implementations, feedback reports to the BS may include PSeqS reports and/or time-domain reporting messages.

In some implementations, the WTRU may provide a PSeqS report in a periodic, semi-periodic, or on-demand fashion to the BS, which may include, without limitation, any or several of the following indications: a preferred padding sequence structure identifier (PSeqS ID); the mean squared error (MSE) of the interference estimation during the signal detection process; the post-detection signal-to-noise ratio (SNR); the high-level performance metrics like bit error rate (BER) or block error rate (BLER), before or after FEC; and/or metrics related to convergence of a Successive Interference Cancellation (SIC) algorithm, like the number of iterations or the residual error.

In some implementations, e.g., when more than one TRP has established a connection with the WTRU, multiple PSeqS reports may be independently sent by the WTRU to multiple TRPs, wherein each report may include any or several of the above indications to any of the TRPs.

In some implementations, PSeqS reports, if sent by the WTRU, may be updated with the required periodicity to follow the rate of variation of the wireless channel and/or the variations in WTRU performance. In some implementations, the periodicity is sufficient to respond to the rate of variation of the wireless channel and/or WTRU performance. In some implementations, PSeqS reports may be sent to the BS e.g., via MAC CE, but other possibilities are possible in other implementations.

In some implementations, the WTRU may also send time-domain reporting messages to the BS, which may include time-domain measurements, e.g., via a control or data channel, e.g., over UCI, or as part of PUSCH. In some implementations, time-domain measurements by the WTRU may be performed over the time-domain signal that results after equalization, e.g., the absolute magnitude of the interference from RS puncturing/insertion, e.g., by discarding of all the frequency subcarriers that are not allocated for that WTRU, e.g., in order to not be affected by the PAPR of the signals intended for other users. In some implementations, time-domain measurements by the WTRU may also be performed after interference cancellation and discarding of all the frequency subcarriers that are not allocated for that WTRU; e.g., time-domain autocorrelations. In some implementations, the number of symbols for time-domain measurements can be indicated by the WTRU in a time-domain measurement configuration information using, e.g., DCI or a semi-periodic/periodic RRC configuration message. In some implementations, the BS may also configure the timing of time-domain reporting messages through e.g., a time-domain reporting configuration information in DCI or an RRC time-domain reporting configuration message.

In some implementations, the complexity in terms of complex multipliers of the detection procedure after the equalization step (e.g., common to prior art techniques), considering the SIC algorithm described below regarding simulations, is given by the following equation:

$${SIC}_{} = M {log}_{2} M + 3 L + {N}_{it} \{ ( {f}_{QAM} ( M ) ) + 2 M \}$$

Here, Nit is the number of SIC iterations and f_{QAM}(·) denotes the nonlinear function that assigns the constellation symbol that is closest to the input symbol, as a function of the length M. This is more complex than the solution described above regarding semi-static insertion of distributed RS at the BS side without UE feedback and the solution described above regarding interleaved RS insertion technique, but, in some implementations, provides better control of PAPR and performance, as developed below in the description of simulation results.

Some implementations relate to dynamic insertion of distributed RS by the WTRU based on configuration information from the BS.

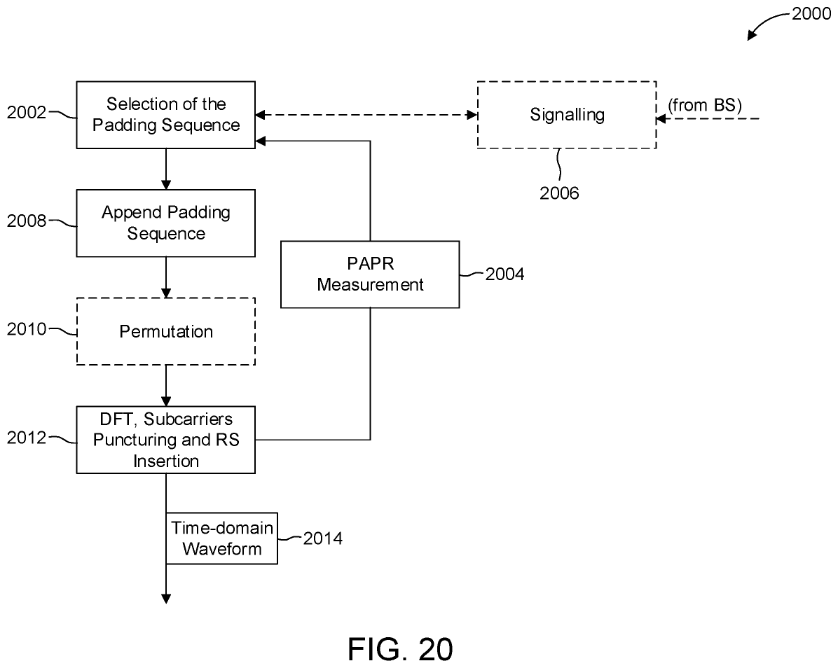

FIG. 20 is a flow chart illustrating an example process 2000 for dynamic RS insertion at the WTRU side. In the example of FIG. 20, the WTRU performs the following steps for dynamic insertion of distributed RS:

In some implementations, one or multiple padding sequences may be selected (e.g., dynamically selected) by the WTRU in step 2002. In some implementations, the padding sequences are selected by the WTRU from among a set of padding sequence structures specified in a pre-determined codebook, e.g., based on PAPR measurements 2004 performed by the WTRU over the current symbol and/or several previous symbols, and/or based on configuration information received from the BS (e.g., in signaling 2006) which may include a set of padding sequences to be used and a set of conditions and the associated sequences to be used by the WTRU, e.g., in RRC. The one or more padding sequences may be appended to the modulated data symbols in step 2008.

In some implementations, a permutation is optionally applied, in step 2010, over the resulting block of data and padding symbols, e.g., in such a way that the complex modulated symbols after permutation are uncorrelated and the permuted positions of the padding symbols are different modulo-L from one another.

In some implementations, an M-point DFT may be performed in step 2012. In some implementations the subcarriers located at the target pilot positions are punctured and replaced by M RS symbols (which can be either complex-valued, or blank). In some implementations, standard DFT-s-OFDM processing follows to generate the time-domain waveform 2014 and PAPR measurements 2004 are performed by the WTRU, e.g., to refine the padding sequence selection in subsequent time intervals.

In some implementations, the WTRU optionally signals to the BS the padding sequence structure or structures used, e.g., by one or multiple padding sequence structure identifier (PSeqS ID) fields, that may be sent once during session establishment and/or dynamically updated during data transfer, or alternatively the sequence identifier(s) can be blindly detected by the BS without the need for explicit signaling. In some implementations, e.g., where the WTRU may transmit the data channel to multiple transmission/reception points (TRP), the WTRU may send multiple PSeqS ID fields, or a combined PSeqS ID field, to the one or multiple TRPs involved in the communication containing indications about the padding sequence structure or structures used.

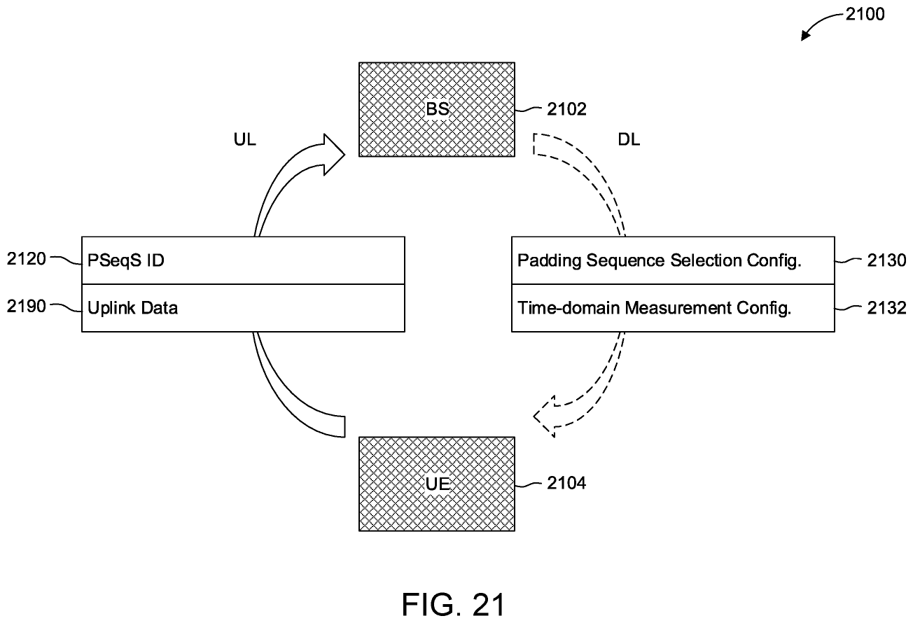

FIG. 21 is chart which illustrates a feedback loop between BS 2102 and WTRU 2104 (shown as a UE in FIG. 21), including uplink data 2190, e.g., for dynamic RS insertion at the WTRU side. In some implementations, the feedback loop 2100 illustrates steps corresponding to steps shown and described with respect to FIG. 20.

In feedback loop 2100, the WTRU 2104 may select a padding sequence structure or structures to use based on PAPR measurements performed by the WTRU 2104 and on padding sequence selection configuration information 2130 received from the BS 2102 including, e.g., a set of sequences to use, and a set of conditions and associated sequences to be used. In some implementations, these conditions may establish, e.g., a set of metrics and associated thresholds designed to trigger different padding sequence structures by the WTRU 2104 upon certain conditions. For example, in some implementations, a PAPR or BER threshold signaled by the BS may trigger the use of one or a set of padding sequence structure types in cases where PAPR or BER statistics exceed that threshold when calculated by the WTRU 2104. In some implementations, criteria for selection of the padding sequence structures may be signaled by the BS, e.g., via RRC signaling, and may also be updated by the gNB, e.g., in MAC CE, DCI, and/or RRC reconfiguration messages.

In some implementations, the WTRU 2104 optionally sends control information to the BS 2102 regarding the padding sequence structure(s) used with a periodicity given by the timescale of the sequence selection process. In some implementations, a padding sequence structure identifier (PSeqS ID) field 2120 may be sent, e.g., once during session establishment (e.g. a default one) as part of e.g. Radio Resource Control (RRC) setup, and/or may be dynamically updated during data transfer within the Uplink Control Information (UCI). In some implementations, the BS 2102 may also perform blind detection of the padding sequence used without the need for explicit signaling.

In some implementations, the timescale of the padding sequence selection process may range from very long (connection-based) to very fast (symbol-based) and adaptive. In some implementations, different timescales are allowed depending on the application and can be influenced by the periodicity of the feedback reports sent by the WTRU 2104. In some implementations, the periodicity of PSeqS ID 2120 indications, if present, may be equal to the timescale of sequence selection (e.g., to provide signaling indications with the same periodicity as the sequence selection process); e.g., in such a way that signaling procedures that are updated over long time periods correspond to long timescales in the sequence selection process and vice versa. In some implementations, blind detection, if used at the BS 2102 side, does not require any signaling of PSeqS ID 2120 from the WTRU. For example, in some implementations, very long means e.g., on the order of minutes, or hours, e.g., as determined by the duration of the connected session. In some implementations, very fast means e.g., on the order of microseconds, e.g., as determined by the duration of the symbols.

In cases where multiple transmission/reception points (TRP) may establish a wireless connection to the WTRU, in some implementations, the WTRU 2104 may send multiple PSeqS ID 2120 fields, or a combined PSeqS ID 2120 field, to the one or multiple TRP containing indications about the padding sequence structure(s) used, e.g. through a single UCI, multiple UCIs associated with different TRP transmissions, or as part of Radio Resource Control (RRC) setup, and/or dynamically updated during data transfer within the UCI.

In some implementations, PAPR measurements may be performed by the WTRU 2104, e.g., in the current symbol and/or several previous symbols. In some implementations, the number of symbols for PAPR measurements may be indicated by the BS 2102, e.g., in a time-domain measurement configuration 2132 information using e.g., DCI or a semi-periodic/periodic RRC configuration message.

The rest of the blocks shown and described with respect to FIG. 20 may be like those shown and described with respect to FIG. 11 and FIG. 17, and involve adding the padding sequence to the input data block, permutation to minimize high undesired autocorrelation, transform precoding, subcarrier puncturing, and insertion of RS symbols, generation of the time-domain signal waveform, and PAPR measurement.

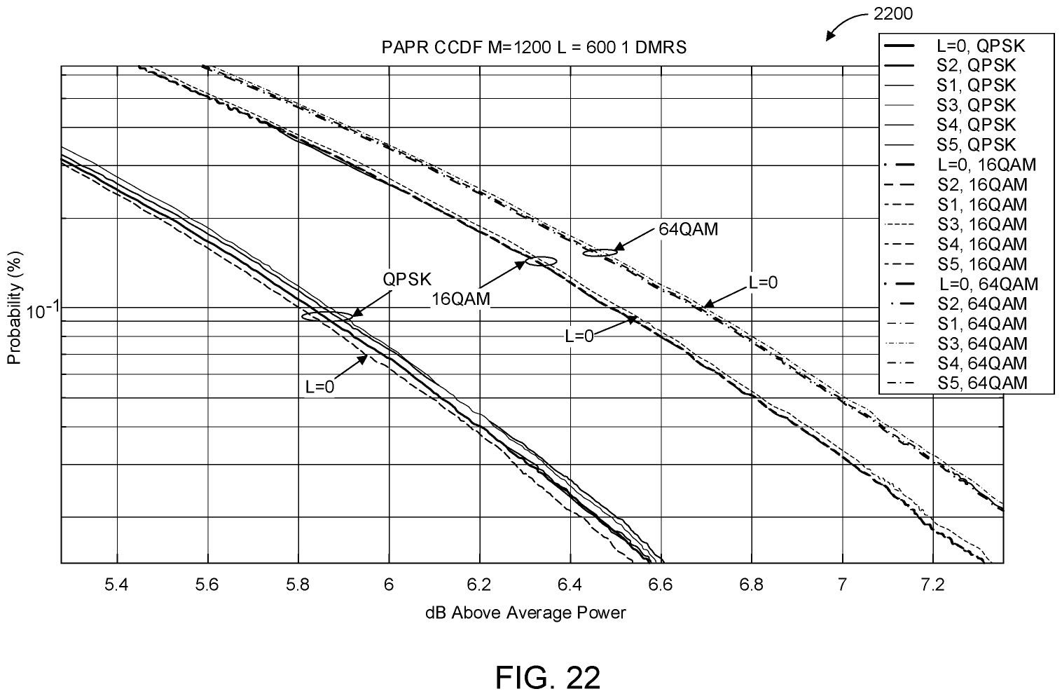

Techniques described herein for post-DFT insertion based on padding sequence adaptation were simulated for the case of DM-RS insertion under different time and frequency patterns. FIGS. 22-27 are graphs illustrating the results of the simulation and compared with the case with no pilots (L=0) and with interleaved RS insertion. Table 1 describes values assumed in the simulation.

TABLE 1
simulation assumptions

| Parameter | Value | Comments |
|---|---|---|
| Channel estimation | Ideal | Genie channel estimator |
| | | with ideal noise estimator |
| | | (An ideal channel |
| | | estimator that provides |
| | | perfect channel |
| | | information) |
| Equalizer | LMMSE | |
| Numerology | NR-like, μ = 0 | Δf = 15 kHz, N = 2048 |
| Channel model | AWGN and Rayleigh | Power-delay profile |
| | TDL Highway NLOS | included 4 taps with |
| | | amplitudes |
| | | 0, −2, −5, −7 dB and |
| | | delays 0, 200, 433, 700 |
| | | ns respectively using |
| | | Jakes Doppler spectrum |
| | | in all taps |
| Speed | 3 kmph | |
| Eb/N0 | From 0 to 33 dB in 1 | |
| | dB/3 dB-steps | |
| Modulation order | QPSK, 16QAM, 64QAM | |
| Carrier frequency | 6 GHz | |
| Number of | 1200 | |
| subcarriers M | | |
| DM-RS pattern | L = 600 DM-RS | In {1, 4} (the cases with |
| | Configuration Type 1 vs. | 1 or 4 DM-RS symbols |
| | L = 0 (no pilots) {1, 4} | inserted) the symbol |
| | DM-RS symbols per slot | numbers were arbitrarily |
| | (i.e., both 1 and 4 | set, and L = 0 refers to |
| | DM-RS symbols were | a DFT-s-OFDM block |
| | simulated. | with no pilots |
| FEC coding | No | |
| DM-RS sequence | Based on Zadoff-Chu | Truncated to L and |
| | with root 25 and length | mapped to periodic |
| | L + 1 | positions with frequency |
| | | shift p = 0 |
| Scenarios | S1 to S5, see (1) below. | |
| Permutation [symbol] {·} | No permutation | Padding sequence was |
| | | directly appended at the |
| | | end of the data block. TX |
| | | power was normalized |
| Detection algorithm | SIC with a maximum of | See pseudo-code (2), |
| | 20 iterations | below |
| SIC stopping | rms of interference < | N₀ is the ideal noise |
| condition | min{10⁻³, N₀/10} | power |
| BER stopping | 200 erroneous slots | Simulation stops when at |
| condition | | least 200 slots of 14 |
| | | DFT-s-OFDM symbols |
| | | each are received with |
| | | errors, see (3) below. |
| PAPR calculation | PAPR CCDF obtained | |
| | after 1000 DFT-s-OFDM | |
| | symbols | |

### (1) Scenario Definitions:

$$\begin{matrix}( constant - envelope ) & \\ x [ m ] = \{ d [ 0 ] , ... , d [ M - L - 1 ] , ZC [ 0 ] , ... , ZC [ L - 1 \} & S1\end{matrix}$$

$$\begin{matrix}( blank ) & \\ x [ m ] = \{ d [ 0 ] , ... , d [ M - L - 1 ] , 0 , ... , 0 \} & S2\end{matrix}$$

$$\begin{matrix}( sign - reversed ) & \\ x [ m ] = \{ d [ 0 ] , ... , d [ M - L - 1 ] , - d [ 0 ] , ... , - d [ L - 1 ] \} & S3\end{matrix}$$

$$\begin{matrix}( phase - shifted ) & \\ x [ m ] = \{ d [ 0 ] , ... , d [ M - L - 1 ] , {e}^{j π / 2} d [ 0 ] , ... , {e}^{j π / 2} d [ L - 1 ] \} & S4\end{matrix}$$

$$\begin{matrix}( interleaved ) & \\ interleaved RS insertion through smaller DFT , for comparsion & S5\end{matrix}$$

### (2) Pseudo-Code Used for SIC Detection:

```
Interf = <estimate first interference from Input>;
Interf_periodic = <repeat Interf (M/L) times to make it periodic>;
MSE = rms(Interf_periodic);
While (MSE > threshold)
  Input = Input − Interf_periodic;
  Data_reconstructed = <find constellation symbols that are closest to
  Input>;
  Interf = <average (Input − Data_reconstructed) over the M/L periods>;
  Interf_periodic = <repeat Interf (M/L) times to make it periodic>;
  MSE = rms(Interf_periodic);
end
```

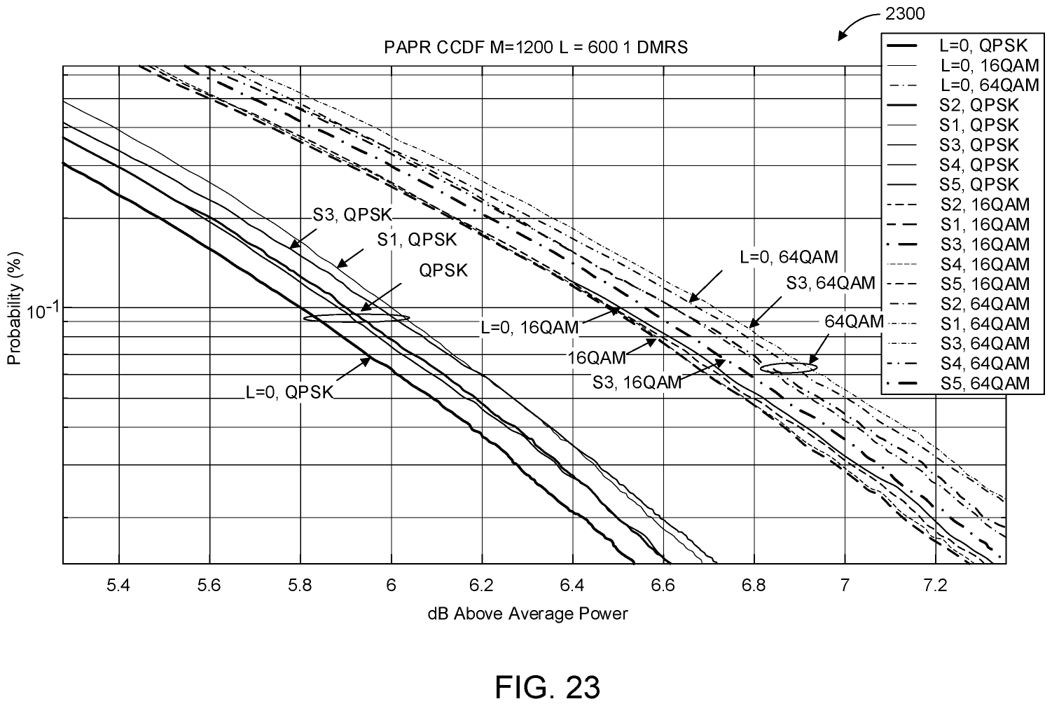

FIGS. 22 and 23 are graphs 2200 and 2300, respectively, which show PAPR results of the simulation, and illustrate the PAPR CCDF values obtained with scenarios S1-S5. FIG. 22 is a line graph 2200 illustrating PAPR for 1 DM-RS symbol. FIG. 23 is a line graph 2300 illustrating PAPR for 4 DM-RS symbols. PAPR increase is negligible with 1 DM-RS symbol, and has only 0.1-0.2 dB increase in QPSK with 4 DM-RS symbols compared to L=0. In 16/64QAM, PAPR is within (−0.05, 0.05) dB from L=0. Although PAPR is in line with that with no pilots, different padding sequence structures yield different PAPR values.

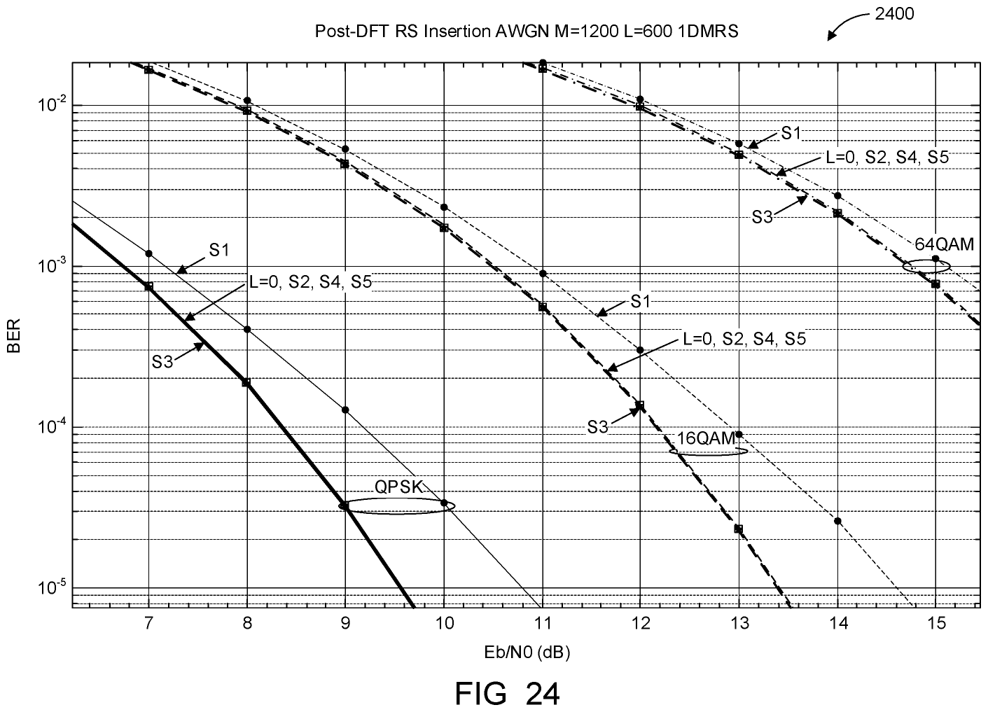

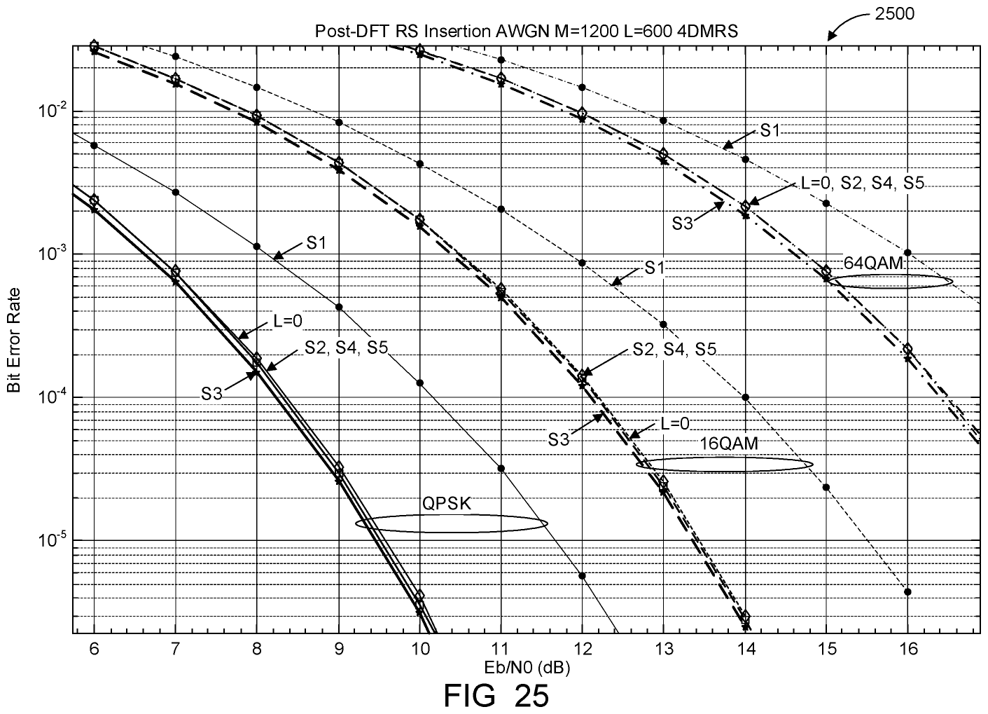

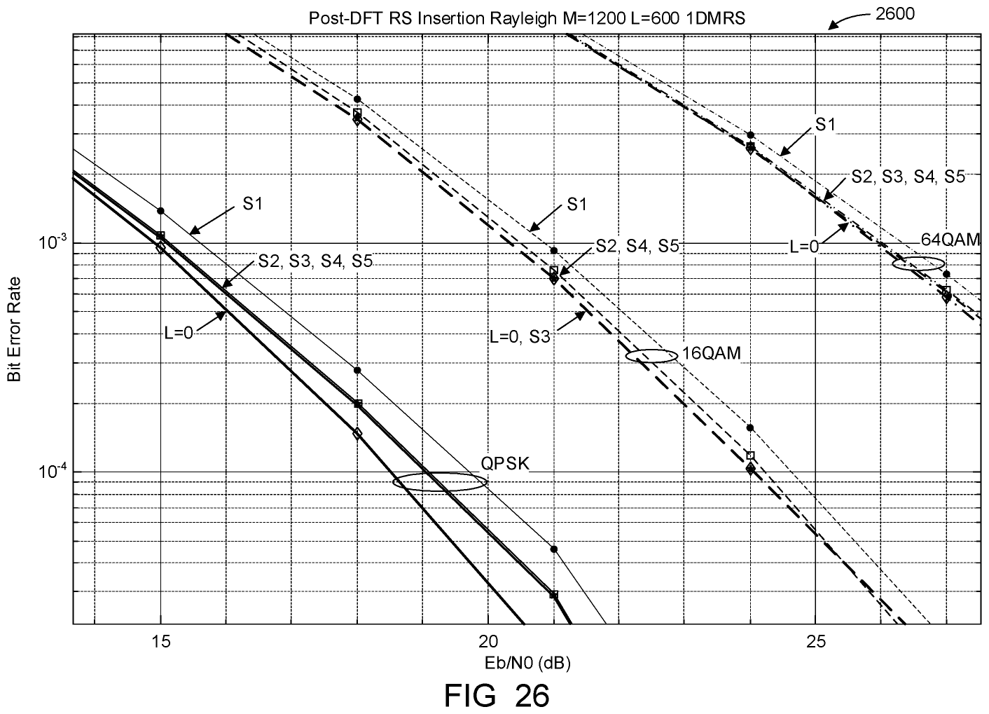

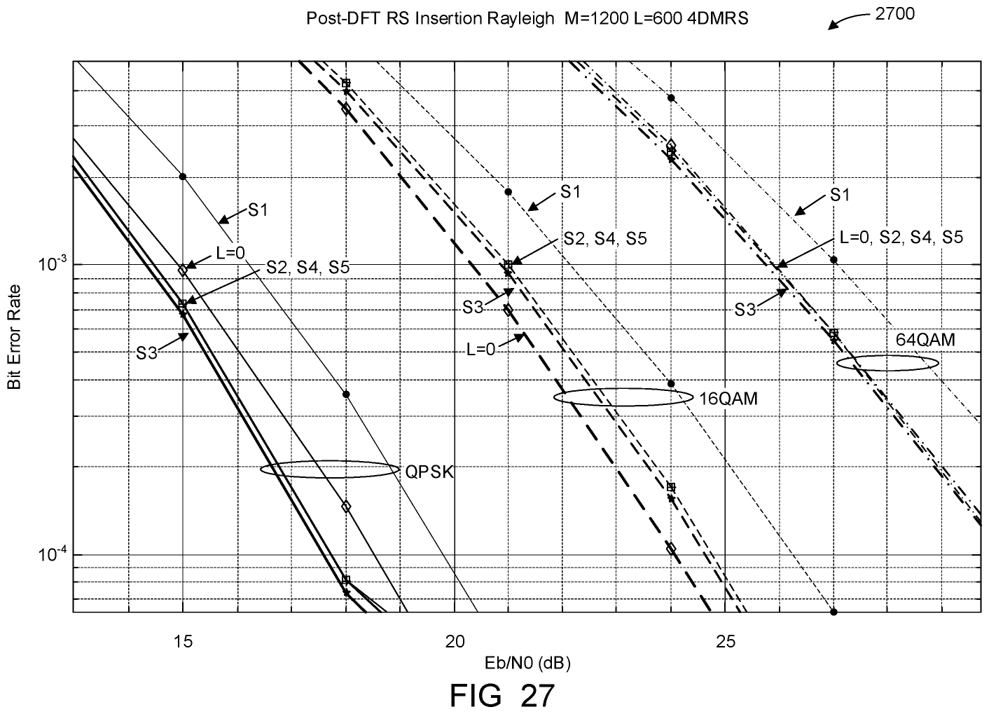

FIGS. 24-27 are graphs 2400, 2500, 2600, and 2700, respectively, which show BER results of the simulation, and which illustrate BER results obtained in scenarios S1-S5. S1 has up to 2 dB SNR increase compared to the no pilot case because of the lower useful energy for data, whereas S3 yields the best performance. FIG. 24 is a line graph 2400 illustrating BER for 1 DM-RS symbol, AWGN. FIG. 25 is a line graph 2500 illustrating BER for 4 DM-RS symbols, AWGN. FIG. 26 is a line graph 2600 illustrating BER for 1 DM-RS symbol, Rayleigh. FIG. 27 is a line graph 2700 illustrating BER for 4 DM-RS symbol, Rayleigh.

The following description illustrates various exemplary implementations, including pre-DFT RS insertion based on IFDMA, post-DFT RS insertion based on padding sequence adaptation (with and without feedback), and data detection based on post-DFT RS insertion with padding sequence adaptation (with and without feedback).

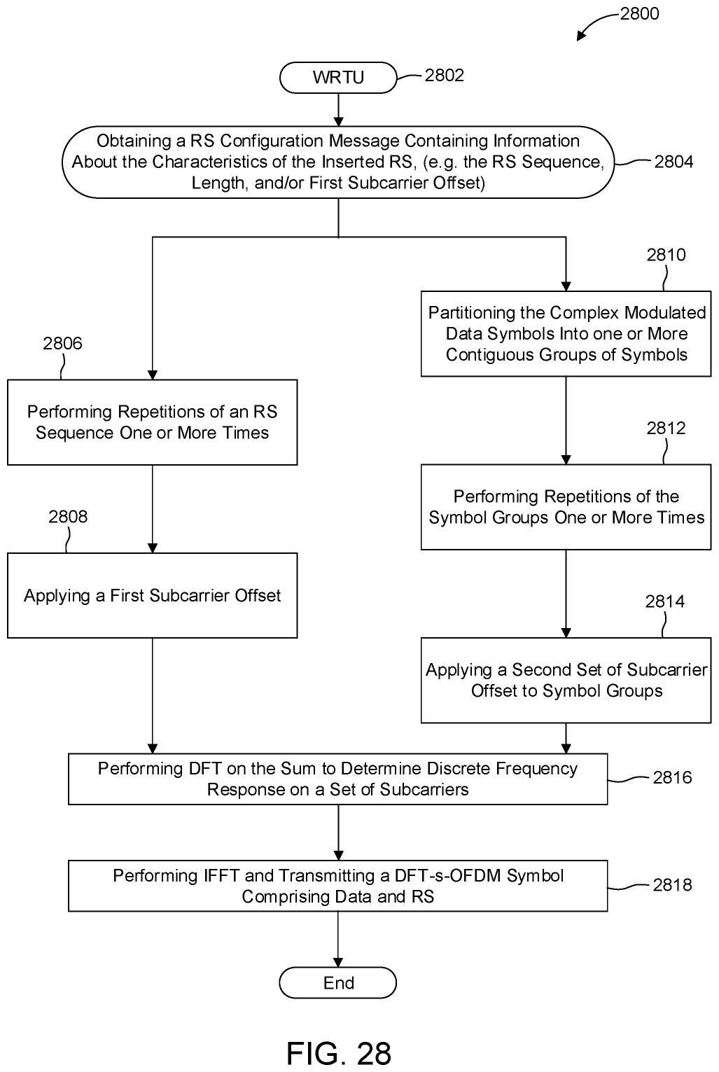

FIG. 28 is a flow chart illustrating an example procedure 2800 relating to detection of shared DFT-s-OFDM symbols with pre-DFT insertion of RS based on IFDMA. In example procedure 2800, a WTRU 2802 transmits shared DFT-s-OFDM symbols between data and RS. In step 2804, WTRU 2802 obtains, in a RS configuration message which includes information about the characteristics of the inserted RS (e.g. the RS sequence to use, its length, or a first subcarrier offset).

In step 2806, WTRU 2802 determines a first set of complex pilot symbols, e.g., by performing repetitions of an RS sequence one or more times. In step 2808, WTRU 2802 generates a second set of complex pilot symbols, e.g., by applying a first subcarrier offset to the first set of complex pilot symbols.

In step 2810, WTRU 2802 generates a first set of complex data symbol groups, e.g., by partitioning the complex modulated data symbols into one or more contiguous groups of symbols. In step 2812, WTRU 2802 generates a second set of complex data symbol groups, e.g., by performing repetitions of each group of symbols in the first set of complex data symbol groups one or more times. In step 2814, WTRU 2802 generates a third set of complex data symbol groups, e.g., by applying a second set of subcarrier offsets to the second set of complex data symbol groups.

In step 2816, WTRU 2802 performs a DFT operation on the sum of the second set of complex pilot symbols and the third set of complex data symbol groups, e.g., to determine the discrete frequency response on a set of subcarriers. In step 2818, WTRU 2802 performs IFFT on said set of subcarriers and transmits a DFT-s-OFDM symbol including data and RS.

In some implementations, the RS configuration message indicates any of an RS sequence to use, first subcarrier offset, allocated number of subcarriers M, and/or number L of RS complex symbols contained in the shared DFT-s-OFDM symbols. In some implementations, the first subcarrier offset is an integer lower than (M/L) expressing the position of the subcarriers containing RS symbols. In some implementations, the RS configuration message is received from a second WTRU or set of second WTRUs via RRC signaling or through DCI or MAC CE indications. In some implementations, the RS configuration message is obtained via an indication from higher layers. In some implementations, repetitions of an RS sequence are such that L RS symbols are repeated M/L times to yield a first set of complex pilot symbols. In some implementations, partitioning of the complex modulated data symbols is done in such a way that (M−L) complex symbols are segmented into L contiguous groups of (M−L)/L complex symbols each to yield a first set of complex data symbol groups. In some implementations, the second set of subcarrier offsets include non-repeating integer values that are lower than L and different than the first subcarrier offset. In some implementations, the complex modulated data symbols may undergo a permutation step prior to partitioning into one or more contiguous groups of symbols to minimize the maximum autocorrelation at time instants other than zero. In some implementations, the size of the DFT operation is the same as the number of subcarriers allocated to the WTRU in the DFT-s-OFDM symbol, including RS and data. In some implementations, the WTRU is a base station equipment in the downlink of a wireless communication system. In some implementations, the WTRU is a user equipment in the uplink of a wireless communication system. In some implementations, the WTRU is a user equipment in the sidelink of a wireless communication system.

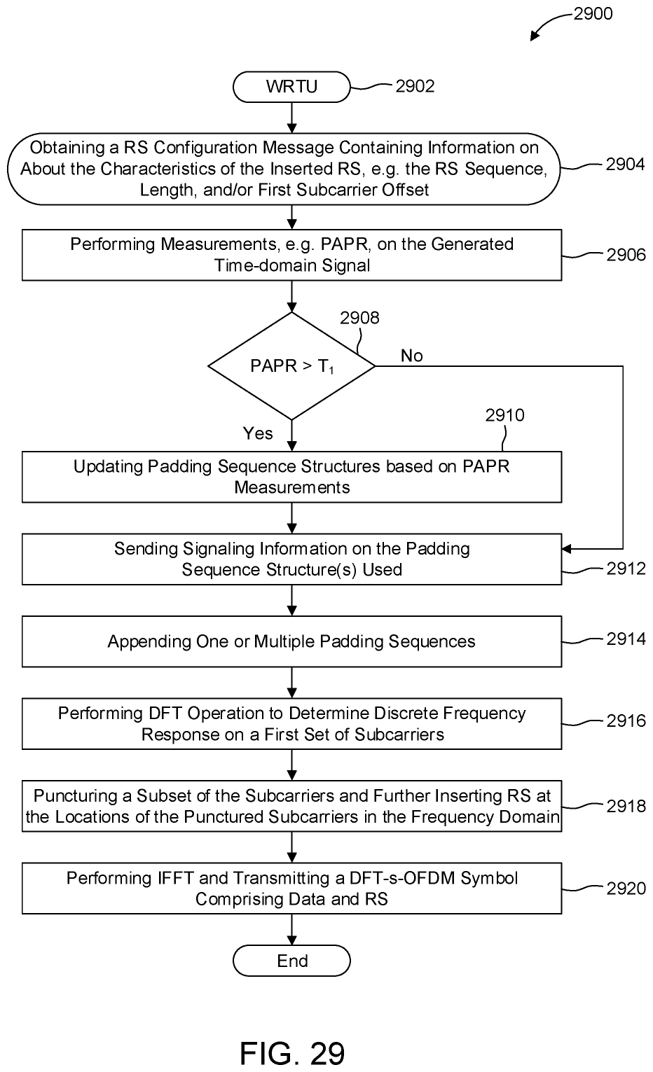

FIG. 29 is a flow chart illustrating an example procedure 2900 relating to transmission of shared DFT-s-OFDM symbols with post-DFT insertion of RS based on padding sequence adaptation without feedback. In example procedure 2900, a first WTRU 2902 (or set of first WTRUs) transmit shared DFT-s-OFDM symbols between data and RS to a second WTRU (or set of second WTRUs).

In step 2904, WTRU 2902 obtains, in a RS configuration message, information about the characteristics of the inserted RS, e.g. the RS sequence to use, its length, or a first subcarrier offset. In step 2906, WTRU 2902 performs measurements, e.g., PAPR, on one or more generated signals, wherein in some implementations the generated signal may be a time domain signal encompassing signals addressed to a second WTRU or a set of second WTRUs;

WTRU 2902 comparing measurements, e.g. PAPR, against a first threshold T₁, and on condition 2908 that the measurements exceed the first threshold T₁, (e.g., PAPR>T₁), WTRU 2902 updates the one or multiple padding sequence structures from a padding sequence structure codebook based on PAPR measurements in step 2910 before sending signaling information to the second WTRU or set of second WTRUs, e.g., on the padding sequence structure or structures used, in step 2912.

Otherwise, on condition 2908 that the measurements do not exceed the first threshold T₁, (e.g., PAPR!>T₁), WTRU 2902 sending signaling information to the second WTRU or set of second WTRUs, e.g., on the padding sequence structure or structures used, in step 2912, without updating the one or multiple padding sequence structures from a padding sequence structure codebook based on PAPR measurements.

In step 2914, WTRU 2902 constructs a first set of symbols, e.g., by appending the one or multiple padding sequences to a second set of complex modulated data symbols in a DFT-s-OFDM symbol. In step 2916, WTRU 2902 performs a DFT operation on the first set of symbols to determine discrete frequency response on a first set of subcarriers. In step 2918, WTRU 2902 punctures a subset of the subcarriers and inserts the complex RS symbols at the locations of the punctured subcarriers in the frequency domain to obtain a second set of subcarriers. In step 2920, WTRU 2902 performs IFFT on the second set of subcarriers and transmitting a DFT-s-OFDM symbol including data and RS.

In some implementations, the RS configuration message includes any of a RS sequence to use, first subcarrier offset, allocated number of subcarriers M, and/or number L of RS complex symbols contained in the shared DFT-s-OFDM symbols. In some implementations, the first subcarrier offset is an integer lower than (M/L) expressing the position of the subcarriers containing RS symbols. In some implementations, the RS configuration message is received from a second WTRU or set of second WTRUs via RRC signaling or through DCI or MAC CE indications. In some implementations, the RS configuration message is received via higher layers, e.g., RRC.

In some implementations, the padding sequence structure codebook may contain a set of padding sequence structures a-priori known by the first WTRU or set of first WTRUs and the second WTRU or set of second WTRUs. In some implementations, PAPR measurements may be performed by the first WTRU or set of first WTRUs over the time-domain signal containing all the data and control information mapped to the subcarriers allocated to the second WTRU at the current DFT-s-OFDM symbol. In some implementations, PAPR measurements may be performed by the first WTRU or set of first WTRUs over the time-domain signal that results after discarding the frequency subcarriers that are not allocated to that WTRU at the current DFT-s-OFDM symbol. In some implementations, the first threshold indicates a requirement to switch to another padding sequence structure with lower PAPR. In some implementations, the number of padding sequences to append to the complex modulated data symbols is determined from the frequency pattern of RS symbols, such that each appended padding sequence can be used to generate one set of RS subcarriers at periodical frequency positions with a periodicity equal to M/L. In some implementations, the length of the padding sequence structures can be the same as, or different to, the number of RS symbols to be inserted.

In some implementations, the selection of the one or multiple padding sequence structures may be based on a-priori known categorization of the padding sequence structures in terms of their PAPR and performance characteristics. In some implementations, the selection of the one or multiple padding sequence structures may be based on PAPR measurements performed by the first WTRU or set of WTRUs on one or several previous DFT-s-OFDM symbols. In some implementations, the selection of the one or multiple padding sequence structures may be based on determining whether PAPR measurements are above or below a given threshold. In some implementations, said threshold may be set by an application or configured by higher layers as a function of pre-determined policies or instantaneous cell conditions. In some implementations, the selection of the one or multiple padding sequence structures may be based on the result of Machine-Learning (ML) algorithms trained to suggest the optimal padding sequences based on measurements. In some implementations, the selection of the one or multiple padding sequence structures may be based on a set of sequences to use and a set of conditions to be fulfilled. In some implementations, said set of conditions may include a set of metrics and associated thresholds designed to trigger different padding sequence structures by the first WTRU or set of first WTRUs upon certain conditions. In some implementations, said set of conditions may be signaled by the second WTRU via RRC signaling, and may be updated e.g. in MAC CE, DCI, and/or RRC reconfiguration messages.

In some implementations, the signaling information to the second WTRU or set of second WTRUs may contain a padding sequence structure indication within a default codebook of padding sequence structures that is a-priori known by the first and the second WTRUs. In some implementations, the padding sequence structure indication may be sent via RRC signaling or through DCI or MAC CE indications by the first WTRU or set of first WTRUs, through, e.g., one or multiple padding sequence structure indications. In some implementations, a permutation may be applied over the M complex symbols after appending the one or multiple padding sequences, in such a way that the permuted positions of the symbols of the padding sequence are different modulo-L from one another and the magnitude of the resulting autocorrelation is minimized at time instants other than zero. In some implementations, the size of the DFT operation is the same as the number of subcarriers allocated to the second WTRU in the DFT-s-OFDM symbol, including RS and data.

In some implementations, the first WTRU is a base station equipment and the second WTRU is a user equipment in the downlink of a wireless communication system. In some implementations, the set of first WTRUs are multiple transmit-receive points in the downlink of a multi-TRP wireless communication system. In some implementations, the first WTRU and the second WTRU are user equipment in the sidelink of a wireless communication system. In some implementations, the first WTRU is a user equipment and the second WTRU is a base station equipment in the uplink of a wireless communication system. In some implementations, the set of second WTRUs are multiple transmit-receive points in the uplink of a multi-TRP wireless communication system.

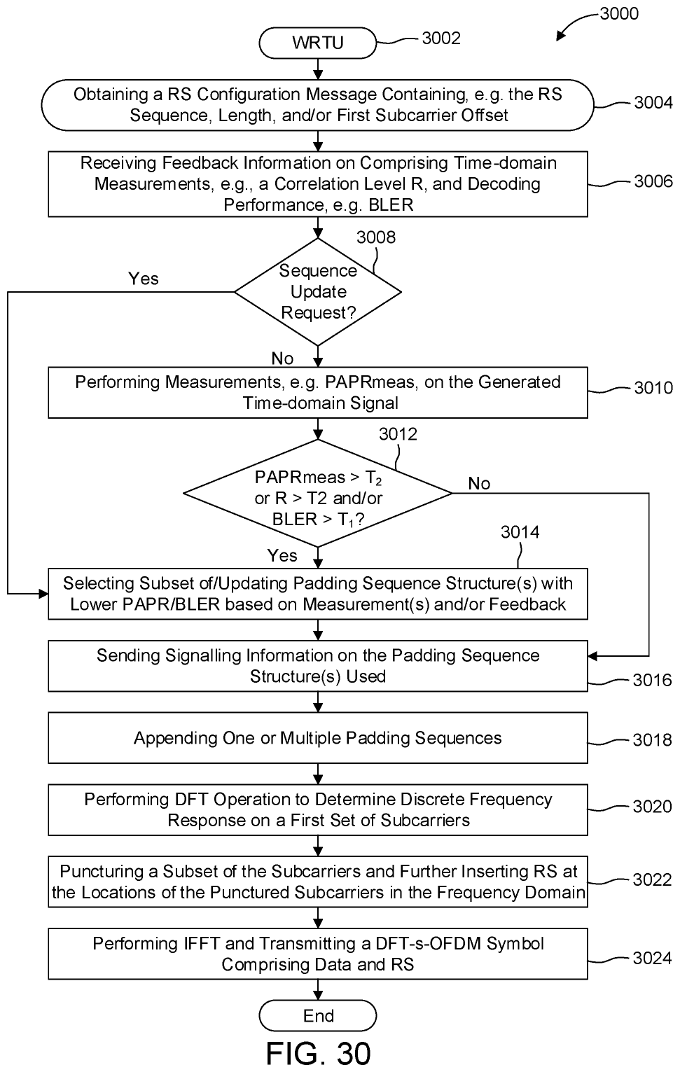

FIG. 30 is a flow chart illustrating an example procedure 3000 relating to transmission of shared DFT-s-OFDM symbols with post-DFT insertion of RS based on padding sequence adaptation with feedback. In example procedure 3000, a first WTRU 3000 (or set of first WTRUs) transmits shared DFT-s-OFDM symbols between data and RS (i.e., symbols that include both data and RS) to a second WTRU (or set of second WTRUs).

In step 3004, WTRU 3002 obtains, in a RS configuration message, information about the characteristics of the inserted RS, e.g., the RS sequence to use, its length, or a first subcarrier offset. In step 3006, WTRU 3002 receives feedback information from the second WTRU, e.g., time-domain reporting messages and decoding performance, e.g., BLER.

On condition 3008 that the feedback information includes a request to update the padding sequence structure, WTRU 3002 selects one or multiple padding sequence structures from a subset of the padding sequence structure codebook characterized by a lower PAPR based on PAPR measurements or feedback information being above a first or second threshold in step 3014.

Otherwise, on condition 3008 that the feedback information does not include a request to update the padding sequence structure, in step 3014, WTRU 3002 performs measurements (e.g., PAPR) on one or more generated signals and compares the measurements against a first threshold, where the generated signal is a time domain signal encompassing signals addressed to a second WTRU or a set of second WTRUs. WTRU 3002 also compares information from time-domain reporting messages, (e.g., the maximum autocorrelation R) against a second threshold, and compares a decoding performance (e.g., BLER) against a third threshold, in step 3010.

On condition 3012 that the measurements exceed the first threshold (e.g., PAPR>T1) and/or the information exceeds the second threshold (e.g., R>T2), and/or the decoding performance exceeds the third threshold (e.g., BLER>T3), in step 3014 WTRU 3002 selects one or multiple padding sequence structures from a subset of the padding sequence structure codebook characterized by a lower PAPR based on PAPR measurements or feedback information being above the first or second threshold, and/or selects one or multiple padding sequence structures from a subset of the padding sequence structure codebook characterized by a lower BLER based on decoding performance being above the third threshold, and in step 3016, WTRU 3002 sends signaling information to the second WTRU or set of second WTRUs, based on (e.g., indicating) the padding sequence structure or structures used.

Otherwise, on condition 3012 that the measurements do not the first threshold (e.g., PAPR!>T1) and the information does not exceed the second threshold (e.g., R!>T2), and the decoding performance does not exceed the third threshold (e.g., BLER!>T3), WTRU 3002 sends signaling information to the second WTRU or set of second WTRUs, based on (e.g., indicating) the padding sequence structure or structures used (e.g., without reselecting padding sequence structures).

In step 3018, WTRU 3002 constructs a first set of symbols by appending the one or multiple padding sequences to a second set of complex modulated data symbols in a DFT-s-OFDM symbol. In step 3020, WTRU 3002 performs a DFT operation on the first set of symbols to determine discrete frequency response on a first set of subcarriers. In step 3022, WTRU 3002 punctures a subset of the subcarriers and inserts the complex RS symbols at the locations of the punctured subcarriers in the frequency domain to obtain a second set of subcarriers. In step 3024, WTRU 3002 performs IFFT on the second set of subcarriers and transmits a DFT-s-OFDM symbol that includes data and RS.

In some implementations, the RS configuration message includes any of a RS sequence to use, first subcarrier offset, allocated number of subcarriers M, and/or number L of RS complex symbols contained in the shared DFT-s-OFDM symbols. In some implementations, the first subcarrier offset is an integer lower than (M/L) expressing the position of the subcarriers containing RS symbols. In some implementations, the RS configuration message is received via higher layers, e.g., RRC. In some implementations, the padding sequence structure codebook may include a set of padding sequence structures a-priori categorized in terms of their PAPR and decoding performance characteristics, and known by the first WTRU or set of first WTRUs and the second WTRU or set of second WTRUs.

In some implementations, the feedback information may include, e.g., one or multiple time-domain reporting messages, or one or multiple padding sequence structure reports, sent by the second WTRU to the first WTRU or set of first WTRUs through, e.g., a single or multiple reporting messages. In some implementations, time-domain reporting messages may include measurements of the absolute magnitude of the interference over the signal that results after equalization and before interference cancellation, performed by the second WTRU in one or several previous DFT-s-OFDM symbols. In some implementations, time-domain reporting messages may include measurements of the maximum autocorrelation of the complex modulated symbols after interference cancellation, performed by the second WTRU in one or several previous DFT-s-OFDM symbols.

In some implementations, the padding sequence structure reports may include any of a request to update the padding sequence structure, a preferred padding sequence structure, and a decoding performance. In some implementations, decoding performance may be based on error rate performance e.g. BER/BLER, mean squared error of the interference estimation, post-detection signal-to-noise ratio, and/or any metrics related to the performance of a successive interference cancellation technique performed by the second WTRU. In some implementations, PAPR measurements may be performed by the first WTRU or set of first WTRUs over the time-domain signal containing all the data and control information mapped to the subcarriers allocated to the second WTRU at the current DFT-s-OFDM symbol.

In some implementations, the first and second threshold indicate a requirement to switch to another padding sequence structure with lower PAPR. In some implementations, the third threshold indicates a requirement to switch to another padding sequence structure with better decoding performance, e.g., lower BLER. In some implementations, the number of padding sequences to append to the complex modulated data symbols is determined from the frequency pattern of RS symbols, e.g., such that each appended padding sequence can be used to generate one set of RS subcarriers at periodical frequency positions with a periodicity equal to M/L. In some implementations, the length of the padding sequence structures can be the same as, or different to, the number of RS symbols to be inserted. In some implementations, the selection of the one or multiple padding sequence structures may be based on determining whether PAPR measurements, or time-domain reporting messages received from the second WTRU, are above given thresholds. In some implementations, said thresholds may be set by an application or configured by higher layers as a function of pre-determined policies or the instantaneous cell conditions.

In some implementations, the selection of the one or multiple padding sequence structures may be based on the result of Machine-Learning (ML) algorithms trained to suggest the optimal padding sequences based on measurements and on the feedback information from the second WTRU. In some implementations, the selection of the one or multiple padding sequence structures may be triggered by an indication from the second WTRU or set of second WTRUs to switch to another padding sequence structure. In some implementations, the selection of the one or multiple padding sequence structures may be based on a set of sequences to use and a set of conditions to be fulfilled. In some implementations, said set of conditions may include a set of metrics and associated thresholds designed to trigger different padding sequence structures by the first WTRU or set of first WTRUs upon certain conditions. In some implementations, said set of conditions may be signaled by the second WTRU via RRC signaling, and may be updated e.g. in MAC CE, DCI, and/or RRC reconfiguration messages.

In some implementations, the signaling information to the second WTRU or set of second WTRUs may contain a padding sequence structure indication within a default codebook of padding sequence structures that is a-priori known by the first and the second WTRUs. In some implementations, the padding sequence structure indication may be sent via RRC signaling or through DCI or MAC CE indications by the first WTRU or set of first WTRUs, through, e.g., one or multiple padding sequence structure indications. In some implementations, the padding sequence structure reports and the time-domain reporting messages may be received by the first WTRU or set of first WTRUs in a periodic, semi-periodic, on-demand or event-based fashion, over a control or data channel, e.g. over UCI, MAC CE or as part of PUSCH. In some implementations, said periodic and semi-persistent reporting may be configured by the first WTRU via higher-layer signaling to use control uplink shared resources, e.g. over PUCCH. In some implementations, said periodic and semi-persistent reporting may be configured to use data uplink shared resources, e.g. over PUSCH, using e.g. new WTRU identity, e.g. X-RNTI, in unique or group basis to decode the DCIs containing the reporting configuration.

In some implementations, said semi-persistent reporting may be configured with a set of reports and a DL MAC CE or DCI to activate/deactivate one of configured set. In some implementations, said on-demand reporting may include a MAC CE or DCI message requesting the second WTRU to send the report with the next available PUCCH resource. In some implementations, said on-demand reporting may be configured with uplink resources on the PUSCH, or through a request by the second WTRU to allocate uplink resources on the PUSCH using e.g. new UE identity, e.g. X-RNTI, in unique or group basis to decode the DCIs containing the reporting configuration. In some implementations, said event-based reporting may be based on threshold(s), or number of receptions or duration (e.g., time-to-trigger) to be used to make the measurements, in order to send a feedback report when an event is triggered, e.g. when a measurement or set of measurements are below/above said threshold(s). In some implementations, said event-based reporting may be received from the second WTRU via an UL MAC CE, RRC, or UCI message.

In some implementations, a permutation may be applied over the M complex symbols after appending the one or multiple padding sequences, e.g., in such a way that the permuted positions of the symbols of the padding sequence are different modulo-L from one another, and/or the maximum magnitude of the autocorrelation is minimized at time instants other than zero. In some implementations, the size of the DFT operation is the same as the number of subcarriers allocated to the second WTRU in the DFT-s-OFDM symbol, including RS and data. In some implementations, the first WTRU is a base station equipment and the second WTRU is a user equipment in the downlink of a wireless communication system. In some implementations, the set of first WTRUs are multiple transmit-receive points in the downlink of a multi-TRP wireless communication system. In some implementations, the first WTRU and the second WTRU are user equipment in the sidelink of a wireless communication system.

Some implementations relate to Data detection based on Post-DFT RS insertion with padding sequence adaptation (e.g., with and without feedback).

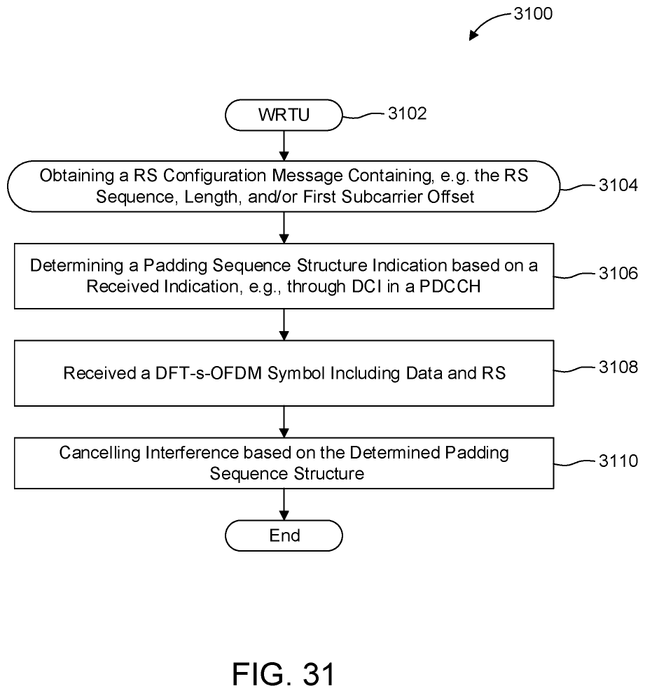

For example, FIG. 31 is a flow chart illustrating an example procedure 3100 relating to detection of shared DFT-s-OFDM symbols with post-DFT insertion of RS based on padding sequence adaptation without feedback. In example procedure 3100, a first WTRU (or set of WTRUs) receives shared DFT-s-OFDM symbols between data and RS from a second WTRU (or set of second WTRUs).

In step 3104, WTRU 3102 obtains, in a RS configuration message, information about the characteristics of the inserted RS (e.g., the RS sequence to use, its length, or a first subcarrier offset). In step 3106, WTRU 3102 determines a padding sequence structure indication (e.g., from a codebook based on a received indication through, e.g., a DCI in a PDCCH message; receiving a DFT-s-OFDM symbol including data and RS). In step 3108, WTRU 3102 receives a DFT-s-OFDM symbol that includes data and RS. In step 3110,

WTRU 3102 cancels interference from subcarrier puncturing and RS insertion (e.g., based on the determined padding sequence structure).

In some implementations, the RS configuration message includes any of a RS sequence to use, first subcarrier offset, allocated number of subcarriers M, or number L of RS complex symbols contained in the shared DFT-s-OFDM symbols. In some implementations, the first subcarrier offset is an integer lower than (M/L) expressing the position of the subcarriers containing RS symbols. In some implementations, the RS configuration message is received from a second WTRU or set of second WTRUs via RRC signaling or through DCI or MAC CE indications. In some implementations, the RS configuration message is received via higher layers, e.g., RRC.

In some implementations, the any of an initial/first padding sequence structure indication and the padding sequence structure codebook may be determined by default based on a dedicated RRC information or through system information. In some implementations, the padding sequence structure indication may be periodically received via RRC signaling or through DCI or MAC CE indications from a second WTRU or set of second WTRUs, e.g., through one or multiple padding sequence structure indications. In some implementations, the padding sequence structure indication may be periodically received via RRC signaling or through UCI or MAC CE indications from a second WTRU. In some implementations, the determination of a padding sequence structure may be based on blind detection and an indication of a subset of the one or more padding sequence structures in the default padding sequence structure codebook.

In some implementations, the first WTRU is a user equipment and the second WTRU is a base station equipment in the downlink of a wireless communication system. In some implementations, the set of second WTRUs are multiple transmit-receive points in the downlink of a multi-TRP wireless communication system. In some implementations, the first WTRU and the second WTRU are user equipment in the sidelink of a wireless communication system. In some implementations, the first WTRU is a base station equipment and the second WTRU is a user equipment in the uplink of a wireless communication system. In some implementations, the set of first WTRUs are multiple transmit-receive points in the uplink of a multi-TRP wireless communication system.

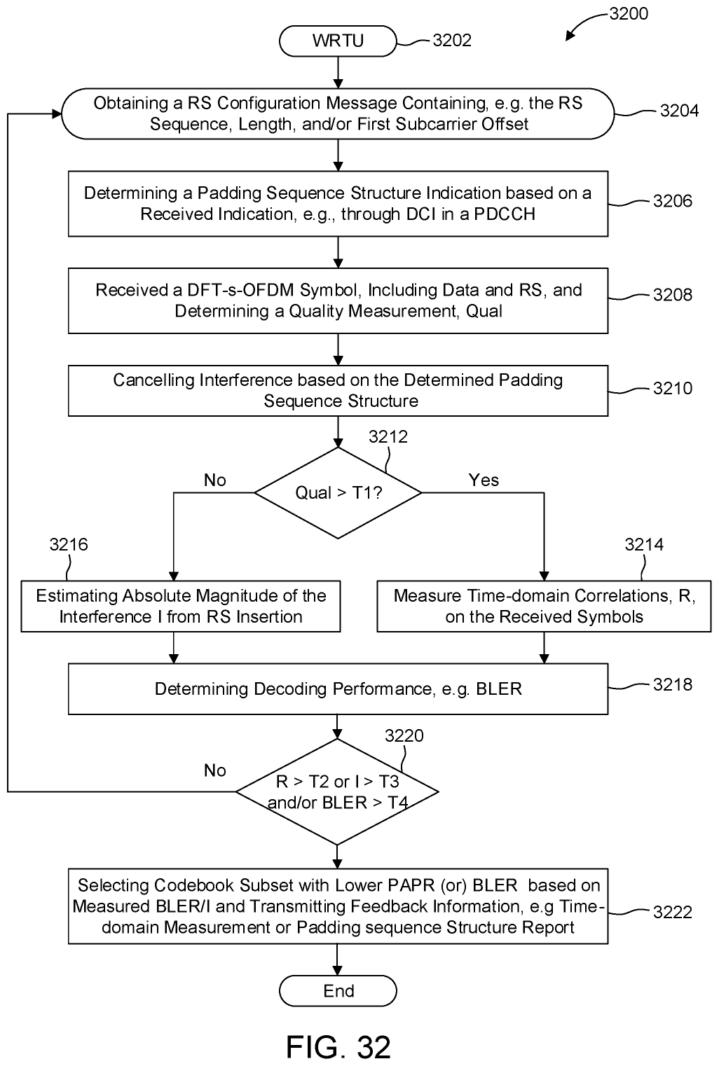

FIG. 32 is a flow chart illustrating an example implementation 3200 relating to detection of shared DFT-s-OFDM symbols with post-DFT insertion of RS based on padding sequence adaptation with feedback. In the example of FIG. 32, a first WTRU 3202 (or set of WTRUs) receive shared DFT-s-OFDM symbols between data and RS from a second WTRU or set of second WTRUs.

In step 3204, WTRU 3202 obtains, in a RS configuration message, information about the characteristics of the inserted RS (e.g., the RS sequence to use, its length, or a first subcarrier offset). In step 3206, WTRU 3202 determines 3206 a padding sequence structure indication from a codebook (e.g., based on a received indication e.g., through a DCI in a PDCCH message). In step 3208, WTRU 3202 receives a DFT-s-OFDM symbol which includes data and RS, and determines a quality indication. In step 3210, WTRU 3202 cancels the interference caused by RS insertion (e.g., based on the determined padding sequence structure).

In step 3214, WTRU 3202 performs time-domain measurement of the maximum autocorrelation of the received signal on condition 3212 that the quality indication is above a first threshold (e.g., Qual>T1), or in step 3216, WTRU 3202 performs time-domain estimation of the absolute magnitude of the interference on the received signal on condition 3212 that the quality indication is not above the first threshold (e.g., Qual!>T1). In step 3218, WTRU 3202 determines a decoding performance (e.g., BLER).

In step 3222, WTRU 3202 selects a codebook subset with lower PAPR on condition 3220 that said maximum autocorrelation is above a second threshold (e.g., R>T2), and/or said interference above a third threshold (I>T3) and/or selects a codebook subset with lower BLER on condition 3220 said decoding performance being above a fourth threshold (e.g., BLER>T4), and transmits feedback information (e.g., time-domain reporting messages or a padding sequence structure report.)

Otherwise, on condition 3220 that said maximum autocorrelation is not above a second threshold (e.g., R!>T2), said interference is not above a third threshold (I!>T3), and said decoding performance is not above a fourth threshold (e.g., BLER>T4), procedure 3200 returns to step 3204, where WTRU 3202 obtains, in a RS configuration message, information about the characteristics of the inserted RS (e.g., the RS sequence to use, its length, or a first subcarrier offset).

In some implementations, the RS configuration message includes any of a RS sequence to use, first subcarrier offset, allocated number of subcarriers M, and/or number L of RS complex symbols contained in the shared DFT-s-OFDM symbols. In some implementations, the first subcarrier offset is an integer lower than (M/L) expressing the position of the subcarriers containing RS symbols. In some implementations, the RS configuration message is received from a second WTRU or set of second WTRUs via RRC signaling or through DCI or MAC CE indications. In some implementations, the any of an initial/first padding sequence structure indication and the padding sequence structure codebook may be determined by default based on a dedicated RRC information or through system information.

In some implementations, the padding sequence structure indication may be periodically received via RRC signaling or through DCI or MAC CE indications from a second WTRU or set of second WTRUs, through, e.g., one or multiple padding sequence structure indications. In some implementations, the determination of a padding sequence structure may be based on blind detection and an indication of a subset of the one or more padding sequence structures in the default padding sequence structure codebook. In some implementations, the quality measurement may include a pre-detection or post-detection signal-to-noise ratio measurement. In some implementations, the time-domain measurements of the maximum autocorrelation and the absolute magnitude of the interference may be performed by the first WTRU after equalization and interference cancellation. In some implementations, the time-domain measurements may be performed over a number of DFT-s-OFDM symbols based on a time-domain measurement configuration information received over e.g. DCI, or a semi-periodic or periodic RRC configuration message. In some implementations, the time-domain measurements may be transmitted in a time-domain reporting message in a periodic, semi-persistent, on-demand or event-based fashion, with a periodicity given by e.g., a time-domain reporting configuration information received in DCI, or an RRC time-domain reporting configuration message.

In some implementations, the second and third thresholds indicate a requirement to transmit feedback information containing a request towards the second WTRU, or set of second WTRUs, to switch to another padding sequence structure with lower PAPR. In some implementations, the fourth threshold indicates a requirement to transmit feedback information containing a request towards the second WTRU, or set of second WTRUs, to switch to another padding sequence structure with better decoding performance, e.g., lower BLER. In some implementations, the decoding performance may be based on error rate performance e.g. BER/BLER, mean squared error of the interference estimation, post-detection signal-to-noise ratio, or any metrics related to the performance of a successive interference cancellation technique performed at the first WTRU. In some implementations, a DFT-s-OFDM symbol is received by means of performing an inverse DFT operation to the discrete frequency contents of the signal. In some implementations, the size of said inverse DFT operation is the same as the number of subcarriers allocated to the second WTRU in the DFT-s-OFDM symbol, including RS and data.

In some implementations, an inverse permutation may be applied over the M complex symbols prior to said cancelling of the interference to restore the original symbol locations after appending the one or multiple padding sequences. In some implementations, the feedback information may include, e.g., one or multiple time-domain reporting messages, or one or multiple padding sequence structure reports. In some implementations, the time-domain reporting messages may include measurements of the interference, or measurements of the maximum autocorrelation at time instants other than zero. In some implementations, the padding sequence structure reports may include any of a request to update the padding sequence structure, a preferred padding sequence structure, and a decoding performance. In some implementations, a padding sequence structure report may be sent to either a second WTRU or a set of second WTRUs through, e.g., a single or multiple padding sequence structure reports. In some implementations, the feedback information may be sent in a periodic, semi-periodic, on-demand or event-based fashion, over a control or data channel, e.g. over UCI, MAC CE or as part of PUSCH, to a second WTRU or set of second WTRUs.

In some implementations, said periodic and semi-persistent reporting may be configured by the second WTRU via higher-layer signaling to use control uplink shared resources, e.g. over PUCCH. In some implementations, said periodic and semi-persistent reporting may be configured to use data uplink shared resources, e.g., over PUSCH, using e.g. new UE identity, e.g. X-RNTI, in unique or group basis to decode the DCIs containing the reporting configuration. In some implementations, said semi-persistent reporting may be configured with a set of reports and a DL MAC CE or DCI to activate/deactivate one of configured set. In some implementations, said on-demand reporting may include a MAC CE or DCI message requesting the first WTRU to send the report with the next available PUCCH resource. In some implementations, said on-demand reporting may be configured with uplink resources on the PUSCH, or through a request by the first WTRU to allocate uplink resources on the PUSCH using e.g. new UE identity, e.g. X-RNTI, in unique or group basis to decode the DCIs containing the reporting configuration.

In some implementations, said event-based reporting may be based on threshold(s), or number of receptions or duration (e.g., time-to-trigger) to be used to make the measurements, in order to send a feedback report when an event is triggered, e.g., when a measurement or set of measurements are below/above said threshold(s). In some implementations, said event-based reporting may be sent to the second WTRU via an UL MAC CE, RRC, or UCI message. In some implementations, the first WTRU is a user equipment and the second WTRU is a base station equipment in the downlink of a wireless communication system. In some implementations, the set of second WTRUs are multiple transmit-receive points in the downlink of a multi-TRP wireless communication system. In some implementations, the first WTRU and the second WTRU are user equipment in the sidelink of a wireless communication system.

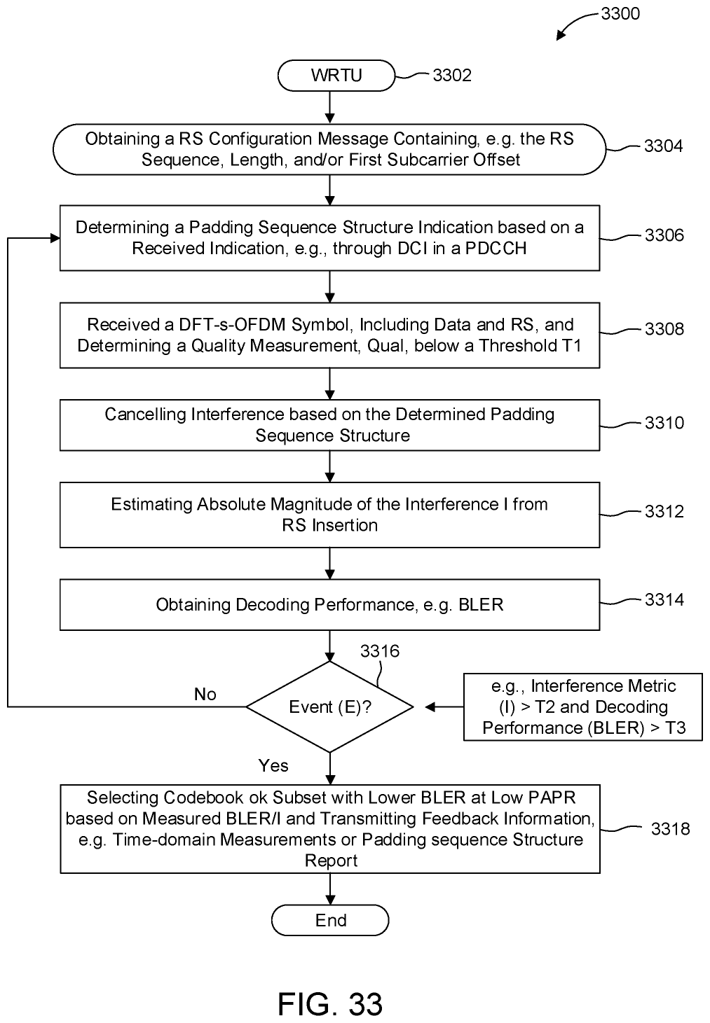

FIG. 33 is a flow chart illustrating an example simplified procedure 3300 for detection of shared DFT-s-OFDM symbols with post-DFT insertion of RS based on padding sequence adaptation with feedback. In procedure 3300, a WTRU 3302 (or set of WTRUs) receiving shared DFT-s-OFDM symbols between data and RS from a second WTRU (or set of second WTRUs).

In step 3304, WTRU 3302 obtains, in a RS configuration message, information about the characteristics of the inserted RS (e.g. the RS sequence to use, its length, and/or a first subcarrier offset). In step 3306, WTRU 3302 determines a padding sequence structure from a codebook (e.g., based on a received indication through, e.g., a DCI in a PDCCH message). In step 3308, WTRU 3302 receives a DFT-s-OFDM symbol including data and RS and determines that a quality measurement (Qual) below a first threshold T1. In step 3310, WTRU 3302 performing time-domain measurement of the interference on the received signal (e.g., based on said quality indication being below the first threshold) and cancels the interference caused by RS insertion (e.g., based on the determined padding sequence structure). In step 3312, WTRU 3302 estimates absolute magnitude of the interference (I) from RS insertion. In step 3314, WTRU 3302 determines or obtains a measurement of decoding performance (e.g., BLER).

On a condition 3316 that an event (E) occurs (e.g., interference power (I) above a second threshold T2 and decoding performance (BLER) above a third threshold T3), WTRU 3302 selects a codebook subset with lower BLER at lowest possible PAPR based on the detected event (E) in step 3318 and transmits feedback information (e.g., time-domain reporting messages or a padding sequence structure report).

Otherwise, on condition 3316 that event (E) does not occur (e.g., interference power (I) is not above a second threshold T2 or decoding performance (BLER) is not above a third threshold T3), procedure 3300 returns to step 3304, where WTRU 3302 obtains, in a RS configuration message, information about the characteristics of the inserted RS (e.g. the RS sequence to use, its length, and/or a first subcarrier offset).

In some implementations, the RS configuration message includes any of a RS sequence to use, first subcarrier offset, allocated number of subcarriers M, and/or number L of RS complex symbols contained in the shared DFT-s-OFDM symbols. In some implementations, the first subcarrier offset is an integer lower than

(M/L) expressing the position of the subcarriers containing RS symbols. In some implementations, the RS configuration message is received from a second WTRU or set of second WTRUs via RRC signaling or through DCI or MAC CE indications.

In some implementations, the any of an initial/first padding sequence structure indication and the padding sequence structure codebook may be determined by default based on a dedicated RRC information or through system information. In some implementations, the padding sequence structure indication may be periodically received via RRC signaling or through DCI or MAC CE indications from a second WTRU or set of second WTRUs, through, e.g., one or multiple padding sequence structure indications. In some implementations, the determination of a padding sequence structure may be based on blind detection and an indication of a subset of the one or more padding sequence structures in the default padding sequence structure codebook.

In some implementations, the quality measurement may include a pre-detection or post-detection signal-to-noise ratio measurement. In some implementations, the estimation of the absolute magnitude of the interference may be performed by the first WTRU over the time-domain signal that results after equalization and interference cancellation. In some implementations, the estimation of the absolute magnitude of the interference may be performed over a number of DFT-s-OFDM symbols based on a time-domain measurement configuration information received over e.g. DCI, or a semi-periodic or periodic RRC configuration message. In some implementations, the estimation of the absolute magnitude of the interference may be transmitted in a time-domain reporting message in an event-based fashion, based on a time-domain reporting configuration information received in DCI, or an RRC time-domain reporting configuration message.

In some implementations, the feedback triggering event includes a second threshold related to an absolute magnitude of the interference indicating a requirement to transmit feedback information containing a request towards the second WTRU, or set of second WTRUs, to switch to another padding sequence structure with lower PAPR. In some implementations, the feedback triggering event includes a third threshold related to a decoding performance indicating a requirement to transmit feedback information containing a request towards the second WTRU, or set of second WTRUs, to switch to another padding sequence structure with better decoding performance, e.g., lower BLER. In some implementations, the feedback triggering event includes a second and a third threshold related to interference and decoding performance respectively, indicating a requirement to transmit feedback information containing a request towards the second WTRU, or set of second WTRUs, to switch to another padding sequence structure with any of a lower PAPR or a lower BLER.

In some implementations, the decoding performance may be based on error rate performance e.g. BER/BLER, mean squared error of the interference estimation, post-detection signal-to-noise ratio, or any metrics related to the performance of a successive interference cancellation technique performed at the first WTRU. In some implementations, a DFT-s-OFDM symbol is received by performing an inverse DFT operation to the discrete frequency contents of the signal. In some implementations, the size of said inverse DFT operation is the same as the number of subcarriers allocated to the second WTRU in the DFT-s-OFDM symbol, including RS and data.

In some implementations, an inverse permutation may be applied over the M complex symbols prior to said cancelling of the interference to restore the original symbol locations after appending the one or multiple padding sequences. In some implementations, the feedback information may include, e.g., one or multiple time-domain reporting messages, or one or multiple padding sequence structure reports. In some implementations, the time-domain reporting messages may include measurements of the absolute magnitude of the interference caused by subcarrier puncturing and RS insertion. In some implementations, the padding sequence structure reports may include any of a request to update the padding sequence structure, a preferred padding sequence structure, and a decoding performance. In some implementations, a padding sequence structure report may be sent to either a second WTRU or a set of second WTRUs through, e.g., a single or multiple padding sequence structure reports.

In some implementations, the feedback information may be sent based on the occurrence of an event over a control or data channel, e.g. over UCI, MAC CE or as part of PUSCH, to a second WTRU or set of second WTRUs. In some implementations, said event-based reporting may be sent to the second WTRU via an UL MAC CE, RRC, or UCI message. In some implementations, the first WTRU is a user equipment and the second WTRU is a base station equipment in the downlink of a wireless communication system. In some implementations, the set of second WTRUs are multiple transmit-receive points in the downlink of a multi-TRP wireless communication system. In some implementations, the first WTRU and the second WTRU are user equipment in the sidelink of a wireless communication system.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-22. (canceled)

23. A method for wireless communications for use in a wireless transmit-receive unit (WTRU), the method comprising:
receiving reference signal (RS) information;
receiving an indication of a padding sequence structure, wherein the padding sequence structure comprises at least one of a constant-envelope sequence, a sign-reversed data symbol, or a phase-shifted data symbol;
receiving a discrete Fourier transform-spread orthogonal frequency division multiplexing (DFT-s-OFDM) symbol which includes data, padding, and an RS;
recovering the data from the DFT-s-OFDM symbol based on the RS information and the indication of the padding sequence structure; and
transmitting feedback based on the recovery of the data.

24. The method of claim 23, wherein the RS information includes an indication of an RS sequence, an indication of an RS length, and/or an indication of a subcarrier offset.

25. The method of claim 23, wherein the RS information is received in a DCI or MAC CE.

26. The method of claim 23, wherein the indication of the padding sequence structure includes an indication of a padding sequence structure identifier or an indication of a codebook index.

27. The method of claim 23, wherein the indication of the padding sequence structure is received in a DCI or MAC CE.

28. The method of claim 23, wherein the padding sequence structure is estimated by blind detection based on the indication of the padding sequence structure.

29. The method of claim 23, wherein recovering the data includes removing interference from the DFT-s-OFDM symbol based on the padding sequence structure, and/or removing interference due to insertion of the RS into the DFT-s-OFDM symbol.

30. The method of claim 23, wherein recovering the data includes removing interference from the DFT-s-OFDM symbol prior to demodulation.

31. The method of claim 29, wherein the feedback includes an indication of a performance of the removal of the interference, and/or an indication of a preferred padding sequence structure.

32. The method of claim 23, wherein the feedback includes an indication of a bit error rate (BER) and/or an indication of a block error rate (BLER).

33. A wireless transmit-receive unit (WTRU) configured for wireless communications, the WTRU comprising:
circuitry configured to receive reference signal (RS) information;
circuitry configured to receive an indication of a padding sequence structure, wherein the padding sequence structure comprises at least one of a constant-envelope sequence, a sign-reversed data symbol, or a phase-shifted data symbol;
circuitry configured to receive a discrete Fourier transform-spread orthogonal frequency division multiplexing (DFT-s-OFDM) symbol which includes data, padding, and an RS;
circuitry configured to recover the data from the DFT-s-OFDM symbol based on the RS information and the indication of the padding sequence structure; and
circuitry configured to transmit feedback based on the recovery of the data.

34. The WTRU of claim 33, wherein the RS information includes an indication of an RS sequence, an indication of an RS length, and/or an indication of a subcarrier offset.

35. The WTRU of claim 33, further comprising circuitry configured to receive the RS information in a DCI or MAC CE.

36. The WTRU of claim 33, wherein the indication of the padding sequence structure includes an indication of a padding sequence structure identifier or an indication of a codebook index.

37. The WTRU of claim 33, further comprising circuitry configured to receive the indication of the padding sequence structure in a DCI or MAC CE.

38. The WTRU of claim 33, further comprising circuitry configured to receive estimate the padding sequence structure by blind detection based on the indication of the padding sequence structure.

39. The WTRU of claim 33, further comprising circuitry configured to recover the data by removing interference from the DFT-s-OFDM symbol based on the padding sequence structure, and/or by removing interference due to insertion of the RS into the DFT-s-OFDM symbol.

40. The WTRU claim 33, further comprising circuitry configured to recover the data by removing interference from the DFT-s-OFDM symbol prior to demodulation.

41. The WTRU of claim 39, wherein the feedback includes an indication of a performance of the removal of the interference, and/or an indication of a preferred padding sequence structure.

42. The WTRU of claim 33, wherein the feedback includes an indication of a bit error rate (BER) and/or an indication of a block error rate (BLER).
